(19) United States
(12) Patent Application Publication
(10) Pub. No.: US 2018/0100478 A1
(43) Pub. Date: Apr. 12, 2018

(54) VALVE DEVICE AND DEVICE FOR MANUFACTURING VALVE DEVICE

(71) Applicant: DENSO CORPORATION, Kariya-city, Aichi-pref (JP)

(72) Inventors: Kouichi MOCHIZUKI, Kariya-city (JP); Eiji ITOH, Kariya-city (JP)

(21) Appl. No.: 15/567,699

(22) PCT Filed: Apr. 8, 2016
(86) PCT No.: PCT/JP2016/001954

§ 371 Date: Oct. 19, 2017

(30) Foreign Application Priority Data
Apr. 24, 2015 (JP) 2015-089207

(51) Int. Cl. F02M 61/18; F02M 61/16; F02M 61/20; F02M 55/00

(52) U.S. Cl. CPC F02M 61/188; F02M 61/168; F02M 61/165; F02M 21/0278; F02M 61/161; F02M 55/008; F02M 61/20

(57) ABSTRACT

A valve device includes a valve housing having a hole and a seat provided on a periphery of the hole, a tubular member, a valve member opening the hole when moving away from the seat and closing the hole when being in contact with the seat, an urging member urging the valve member in a valve closing direction or a valve opening direction, an intermediate member being immovably relative to the tubular member, an adjusting member having a communication passage and configured to adjust an urging force of the urging member via the intermediate member according to a position relative to the tubular member when fixed to the tubular member, and a swelling member provided between the intermediate member and the tubular member and configured to be in contact with the intermediate member and the tubular member by swelling when touched with a fluid flowing through the hole.

### CROSS REFERENCE TO RELATED APPLICATION

This application is based on Japanese Patent Application No. 2015-89207 filed on Apr. 24, 2015, the disclosure of which is incorporated herein by reference.

### TECHNICAL FIELD

The present disclosure relates to a valve device and to a device for manufacturing a valve device.

### BACKGROUND ART

A fuel injection valve in the related art injects fuel in a housing by opening and closing an injection hole provided to the housing with a sliding motion of a needle. The fuel injection valve includes a drive portion capable driving the needle in a valve opening direction, and a spring urging the needle in a valve closing direction. When the fuel injection valve injects fuel, a driving force outputted from the drive portion and an urging force of the spring act on the needle. An urging force of the spring is determined by a distance between an adjusting pipe press-fit and fixed to the housing and the needle. It is therefore necessary to adjust a position at which to fix the adjusting pipe with accuracy when the fuel injection valve is manufactured. For example, Patent Literature 1 describes a fuel injection valve adjusting method, by which a push-in amount of the adjusting pipe into a fixed core and a control value of a control current supplied to the drive portion are varied while maintaining a fluid flowing through the fuel injection valve at a constant flow rate, and a push-in amount of the adjusting pipe is adjusted for the control current to take a target control value.

### PRIOR ART LITERATURES

### Patent Literature

Patent Literature 1: JP3622660B2

### SUMMARY OF INVENTION

However, the fuel injection valve adjusting method described Patent Literature 1 is a method of so-called wet adjustment to adjust a feed amount of the adjusting pipe while a fluid is kept supplied into the fuel injection valve. Hence, man-hours required to adjust an urging force of the spring are increased.

The present disclosure has an object to provide a valve device capable of setting an urging force of an urging member at a high degree of accuracy while cutting a time required to adjust an urging force shorter.

According to an aspect of the present disclosure, the valve device includes a valve housing having a hole through which a fluid flows and a seat provided on a periphery of the hole, a tubular member fixed to an inner side of the valve housing or formed integrally with the valve housing, a valve member being slidable in the valve housing to open the hole when moving away from the seat and to close the hole when being in contact with the seat, an urging member being in contact with the valve member at a first end of the urging member, the urging member urging the valve member in a valve closing direction or a valve opening direction, an intermediate member being in contact with a second end of the urging member, and an adjusting member press-fit and fixed to an inner side of the tubular member to be in contact with the intermediate member on a side opposite to a side being in contact with the urging member, the adjusting member having a communication passage through which a side opposite to the hole and a side of the hole communicate with each other, the adjusting member configured to adjust an urging force of the urging member via the intermediate member according to a position relative to the tubular member when fixed to the tubular member.

In a case where the intermediate member is provided movably relative to the tubular member in the valve device of the present disclosure either as a finished product or in practical use, an urging force of the urging member is detected via the intermediate member when the valve device of the present disclosure is manufactured. The adjusting member is press-fit to and fixed at a position at which an urging force of the urging member reaches a predetermined urging force based on a relationship of the detected urging force of the urging member and a position of the intermediate member. A position at which to fix the adjusting member can be thus determined according to a variance in urging force of the urging member. Hence, an urging force of the urging member can be adjusted not by wet adjustment but by dry adjustment which does not require a fluid in contrast to the wet adjustment which requires an actually flowing fluid to determine a fixed-position of the adjustment member according to a variance in flow rate of the fluid. Consequently, a time required to adjust an urging force of the urging member can be shorter. In addition, in the valve device of the present disclosure, the intermediate member is provided movably relative to the tubular member. Hence, an urging force of the urging member acting on the intermediate member can be detected at a high degree of accuracy. Consequently, the adjusting member can be fixed for an urging force of the urging member to reach a predetermined urging force. The valve device of the present disclosure either as a finished product or in practical use is thus capable of setting an urging force of the urging member at a high degree of accuracy.

Conversely, in a case where the intermediate member is provided immovably relative to the tubular member in the valve device of the present disclosure either as a finished product or in practical use, the intermediate member is made movable relative to the tubular member when the valve device of the present disclosure is manufactured to detect an urging force of the urging member via the intermediate member and fix the adjusting member according to the detected urging force of the urging member as described above. After the adjusting member is fixed, the intermediate member is made immovable relative to the tubular member. Accordingly, the valve device of the present disclosure either as a finished product or in practical use is capable of preventing a variance in position of the intermediate member caused by resistance of a fluid flowing inside the valve device. The valve device of the present disclosure is thus capable of setting an urging force of the urging member at a high degree of accuracy while cutting a time required to adjust an urging force of the urging member shorter by making the intermediate member movable relative to the tubular member during manufacturing. Meanwhile, the valve device of the present disclosure is also capable of stabilizing an urging force of the urging member by making the intermediate member immovable relative to the tubular member in practical use.

### BRIEF DESCRIPTION OF DRAWINGS

The above and other objects, features and advantages of the present disclosure will become more apparent from the following detailed description made with reference to the accompanying drawings. In the drawings:

FIG. 1 is a sectional view of a fuel injection valve according to a first embodiment of the present disclosure;

FIG. 2 is schematic view of the fuel injection valve according to the first embodiment of the present disclosure;

FIG. 3 is a schematic view of the fuel injection valve during manufacturing to describe an adjusting method of an urging force of a spring in the fuel injection valve according to the first embodiment of the present disclosure;

FIG. 4 is a schematic view of the fuel injection valve during manufacturing in a state different from the state shown in FIG. 3 to describe the adjusting method of an urging force of the spring in the fuel injection valve according to the first embodiment of the present disclosure;

FIG. 5 is a schematic view of the fuel injection valve during manufacturing in a state different from the states shown in FIGS. 3 and 4 to describe an adjusting method of an urging force of the spring in the fuel injection valve according to the first embodiment of the present disclosure;

FIG. 6 is a characteristic view showing a relationship of a position of an adjusting pipe and an urging force of the spring in the fuel injection valve according to the first embodiment of the present disclosure;

FIG. 7 is a characteristic view showing a relationship of a time from an issuance of a fuel injection start command and a fuel injection amount in the fuel injection valve according to the first embodiment of the present disclosure;

FIG. 8 is a schematic view to describe an adjusting method of an urging force of a spring in a fuel injection valve according to a second embodiment of the present disclosure;

FIG. 9 is a schematic view of a fuel injection valve according to a third embodiment of the present disclosure;

FIG. 10 is a schematic view of a fuel injection valve according to a fourth embodiment of the present disclosure;

FIG. 11 is a schematic view of a device for manufacturing a fuel injection valve according to a fifth embodiment of the present disclosure;

FIG. 12 is a schematic view to describe an adjusting method of a device for manufacturing a fuel injection valve according to a sixth embodiment of the present disclosure;

FIG. 13 is a schematic view of a fuel injection valve according to a seventh embodiment of the present disclosure;

FIG. 14 is a schematic view of a fuel injection valve according to an eighth embodiment of the present disclosure;

FIG. 15 is a schematic view of a fuel injection valve according to a ninth embodiment of the present disclosure;

FIG. 16 is a schematic view of a fuel injection valve according to a tenth embodiment of the present disclosure;

FIG. 17 is a schematic view of the fuel injection valve during manufacturing to describe an adjusting method of an urging force of a spring in the fuel injection valve according to the tenth embodiment of the present disclosure;

FIG. 18 is a schematic view of the fuel injection valve during manufacturing in a state different from the state shown in FIG. 17 to describe the adjusting method of an urging force of the spring in the fuel injection valve according to the tenth embodiment of the present disclosure;

FIG. 19 is a schematic view of the fuel injection valve during manufacturing in a state different from the states shown in FIGS. 17 and 18 to describe the adjusting method of an urging force of the spring in the fuel injection valve according to the tenth embodiment of the present disclosure;

FIG. 20 is a schematic view of a fuel injection valve according to an eleventh embodiment of the present disclosure;

FIG. 21 is a sectional view taken along the line XXI-XXI of FIG. 20;

FIG. 22 is a schematic view of a fuel injection valve according to a twelfth embodiment of the present disclosure;

FIG. 23 is a schematic view of a valve device according to a fourteenth embodiment of the present disclosure; and

FIG. 24 is a schematic view of a fuel injection valve according to a fifteenth embodiment of the present disclosure.

### DESCRIPTION OF EMBODIMENTS

Hereinafter, multiple embodiments of the present disclosure will be described according to the drawings.

### First Embodiment

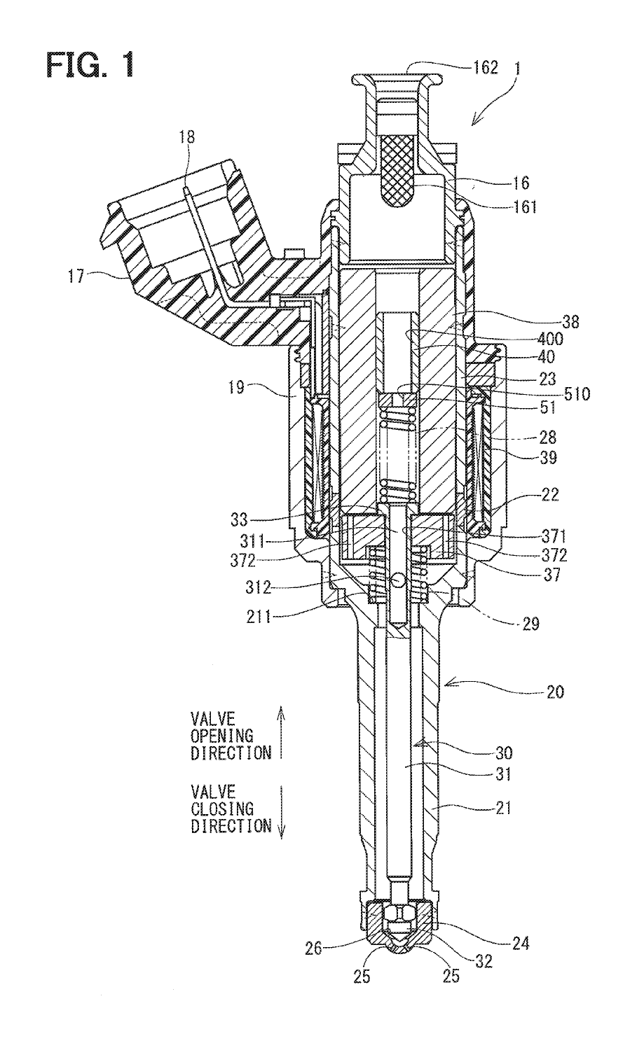

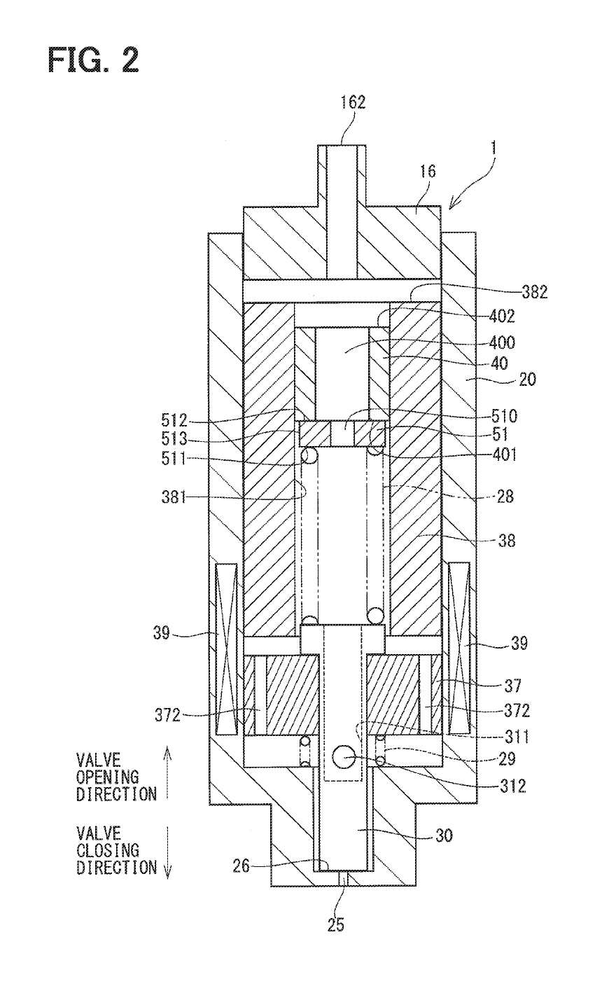

FIGS. 1 and 2 show a fuel injection valve 1 as a valve device according to a first embodiment of the present disclosure. FIGS. 1 and 2 show a valve opening direction in which a needle 30 moves away from a seat 26 and a valve closing direction in which the needle 30 comes into contact with the seat 26.

The fuel injection valve 1 is employed in, for example, an unillustrated fuel injection device of a gasoline direct-injection engine, and supplies the engine with fuel by injecting high-pressure gasoline as the fuel to the engine. The fuel injection valve 1 includes a housing 20 as a valve housing, the needle 30 as a valve member, a movable core 37, a fixed core 38 as a tubular member, a coil 39, springs 28 and 29 as an urging member, an adjusting pipe 40 as an adjusting member, and an intermediate member 51.

As shown in FIG. 1, the housing 20 includes a first tubular member 21, a second tubular member 22, a third tubular member 23, and an injection nozzle 24.

The first tubular member 21, the second tubular member 22, and the third tubular member 23 are all formed in substantially a cylindrical shape, and disposed coaxially in order of the first tubular member 21, the second tubular member 22, and the third tubular member 23 to connect to each other.

The injection nozzle 24 is provided at an end of the first tubular member 21 on a side opposite to the second tubular member 22. The injection nozzle 24 is formed in a tubular shape with a closed bottom. At the bottom, the injection nozzle 24 has an injection hole 25 as a hole, through which an interior and an exterior of the housing 20 communicate with each other. The seat 26 is provided on a periphery of the injection hole 25 on an inner side.

The needle 30 includes a shaft portion 31, a seal portion 32, and a flange portion 33. The shaft portion 31, the seal portion 32, and the flange portion 33 are formed integrally.

The shaft portion 31 is formed in a cylindrical rod shape. The shaft portion 31 has a passage 311 at an end on a side of the fixed core 38. The passage 311 communicates with an inner side of the fixed core 38. The passage 311 also communicates with a side of the injection hole 25 of the movable core 37 via a through-hole 312 radially penetrating through the shaft portion 31.

The seal portion 32 is provided at an end of the shaft portion 31 on the side of the injection hole 25. The seal portion 32 is allowed to make contact with the seat 26.

The flange portion 33 is provided on a radially outer side of the shaft portion 31 at an end on a side opposite to the seal portion 32. At an end face on the side of the injection hole 25, the flange portion 33 is in contact with the movable core 37.

The needle 30 is slidable in the housing 20. The needle 30 opens the injection hole 25 when the seal portion 32 moves away from the seat 26 and closes the injection hole 25 when the seal portion 32 makes contact with the seat 26 to open and close communication between the interior and the exterior of the housing 20.

The movable core 37 is formed in substantially a cylindrical shape and provided on the side of the injection hole 25 of the flange portion 33. Magnetic stabilization treatment is applied to the movable core 37. A through-hole 371 is provided to the movable core 37 substantially at a center. The shaft portion 31 of the needle 30 is passed through the through-hole 371. A passage 372 is provided in a radially outward direction of the through-hole 371 to let both sides of the movable core 37, that is, a side of the fixed core 38 and the side of the injection hole 25 communicate with each other.

The fixed core 38 is formed in substantially a cylindrical shape and provided on a side of the movable core 37 opposite to the injection hole 25. Magnetic stabilization treatment is applied to the fixed core 38. The fixed core 38 is welded to the third tubular member 23 of the housing 20 and fixed on the inner side of the housing 20.

The coil 39 is formed in substantially a cylindrical shape and provided to surround chiefly a radially outer side of the second tubular member 22 and the third tubular member 23. The coil 39 generates a magnetic field when power is supplied. When a magnetic field is generated around the coil 39, a magnetic circuit is formed in the fixed core 38, the movable core 37, the first tubular member 21, the third tubular member 23, and a holder 19. A magnetic attraction force is thus generated between the fixed core 38 and the movable core 37 and the movable core 37 is attracted to the fixed core 38. The needle 30, which is in contact with an end face of the movable core 37 on a side opposite to the seat 26, moves with the movable core 37 toward the fixed core 38, that is, in the valve opening direction.

The spring 28 is a compressed spring and provided in such manner that a first end makes contact with an end face of the flange portion 33 on a side opposite to the injection hole 25. A second end of the spring 28 is in contact with the intermediate member 51. The spring 28 has an axially stretching force. The spring 28 urges the needle 30 together with the movable core 37 in a direction to the seat 26, that is, in the valve closing direction.

The spring 29 is a compressed spring and provided in such a manner that a first end makes contact with an end face of the movable core 37 on the side of the injection hole 25. A second end of the spring 29 is in contact with an inner wall 211 of the first tubular member 21. The spring 29 has an axially stretching force. The spring 29 urges the movable core 37 together with the needle 30 in a direction opposite to the seat 26, that is, in the valve opening direction.

In the present embedment, an urging force of the spring 28 is set larger than an urging force of the spring 29. Accordingly, when no power is supplied to the coil 39, the seal portion 32 of the needle 30 is seated in the seat 26, that is, the fuel injection valve 1 is in a closed state.

The adjusting pipe 40 is a tubular member provided inside the fixed core 38. The adjusting pipe 40 is formed to have an outer diameter equal to an inner diameter of the fixed core 38. The adjusting pipe 40 is press-fit and fixed inside the fixed core 38. The adjusting pipe 40 has one communication passage 400 at substantially a center, through which a side of the adjusting pipe 40 opposite to the injection hole 25 and a side of the injection hole 25 communicate with each other.

The intermediate member 51 is provided between the adjusting pipe 40 and the spring 28. At an end face 511 on the side of the injection hole 25, the intermediate member 51 is in contact with the second end of the spring 28. At an end face 512 on the side opposite to the injection hole 25, the intermediate member 51 is in contact with an end face 401 of the adjusting pipe 40 on the side of the injection hole 25. In the first embodiment, a clearance is provided between an outer wall 513 on a radially outer side of the intermediate member 51 and an inner wall 381 on a radially inner side of the fixed core 38. Hence, the intermediate member 51 is movable relative to the fixed core 38. The intermediate member 51 has a communication hole 510, through which a side opposite to the injection hole 25 and a side of the injection hole 25 communicate with each other.

A fuel introduction pipe 16 that is a substantially cylindrical shape is press-fit and welded to the third tubular member 23 at an end opposite to the second tubular member 22. A filter 161 is provided on an inner side of the fuel introduction pipe 16. The filter 161 filters out foreign matter from fuel flowing inside from an introduction port 162 of the fuel introduction pipe 16.

Radially outer sides of the fuel introduction pipe 16 and the third tubular member 23 are molded with resin. A connector 17 is provided to a molded portion. A terminal 18 to supply power to the coil 39 is insert-molded to the connector 17. The coil 39 is covered with the holder 19 of a tubular shape provided on a radially outer side of the coil 39.

A part of fuel flowing inside from the introduction port 162 of the fuel introduction pipe 16 is introduced into the injection nozzle 24 after flowing through an interior of the fixed core 38, the communication passage 400, the communication hole 510, the passage 311, the through-hole 312, and a clearance between the first tubular member 21 and the shaft portion 31 of the needle 30. Another part of fuel flowing inside from the introduction port 162 is introduced into the injection nozzle 24 after flowing through the interior of the fixed core 38, the communication passage 400, the communication hole 510, a space between the flange portion 33 and the fixed core 38, the passage 372, and the clearance between the first tubular member 21 and the shaft portion 31 of the needle 30. In short, a passage from the introduction port 162 of the fuel introduction pipe 16 to the clearance between the first tubular member 21 and the shaft portion 31 of the needle 30 forms a fuel passage to introduce fuel into the injection nozzle 24.

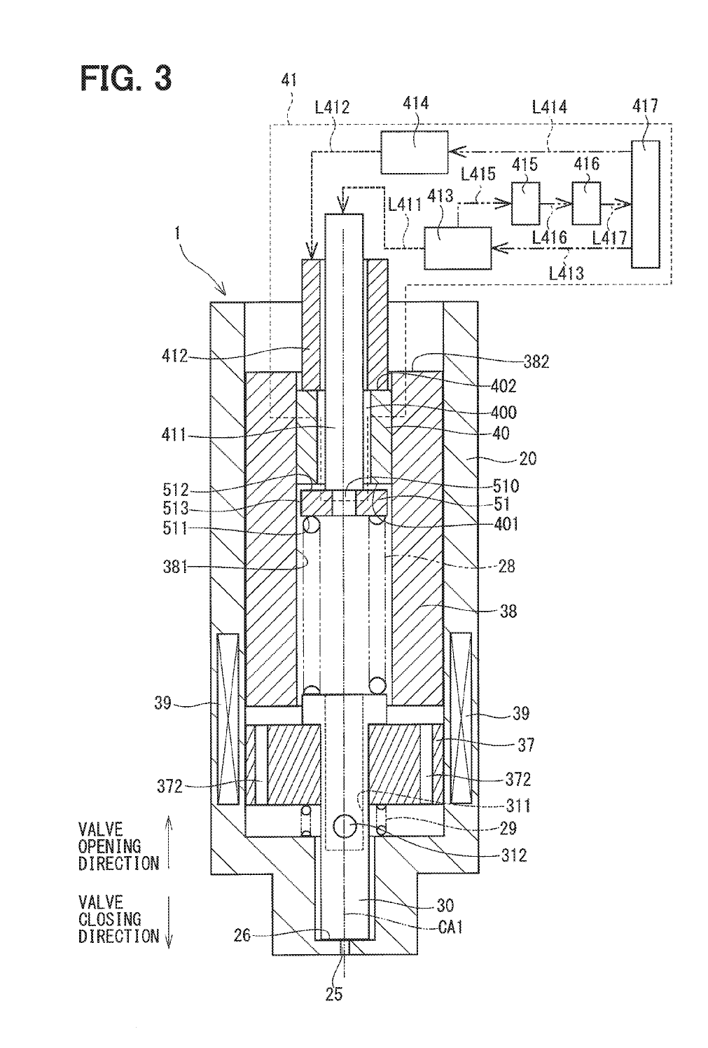

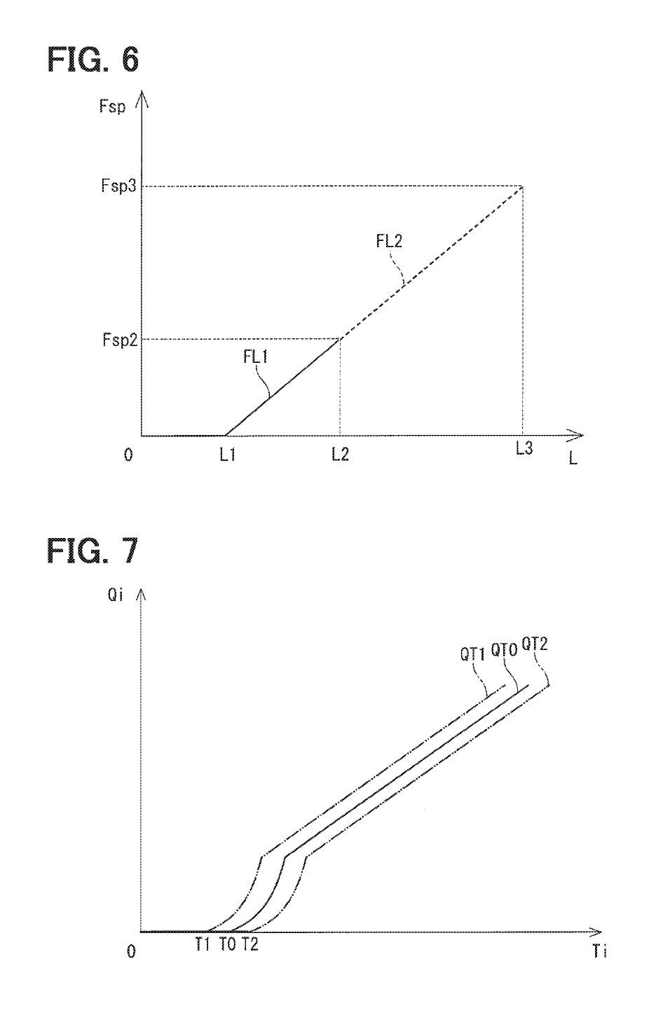

An adjusting process of an urging force of the spring 28 during manufacturing of the fuel injection valve 1 will now be described according to FIGS. 3 to 6. FIG. 6 shows a relationship of a position of the adjusting pipe 40 and an urging force of the spring 28. In FIG. 6, an abscissa is used for a position of the adjusting pipe 40 with respect to the fixed core 38. More specifically, the abscissa is used for a distance L from an end face 382 of the fixed core 38 on the side opposite to the injection hole 25 to an end face 402 of the adjusting pipe 40 in a direction of a center axis CA1. That is, the distance L is zero when the end face 382 and the end face 402 are flush with each other. When the adjusting pipe 40 located at a position of the distance L=0 moves in the valve closing direction, the distance L takes a positive value.

Firstly, a configuration of an urging force adjusting device 41 as a device for manufacturing a valve device used in the adjusting process of an urging force of the spring 28 will be described.

The urging force adjusting device 41 includes a first jig 411, a second jig 412, a first drive portion 413 driving the first jig 411, a second drive portion 414 driving the second jig 412, a detection portion 415, a calculation portion 416, and a control portion 417 controlling the two drive portions.

The first jig 411 is a member of substantially a rod shape. The first jig 411 is linked to the first drive portion 413 (chain line L411 of FIG. 3). The first jig 411 is slidable in the direction of the center axis CA1 of the fuel injection valve 1. The first jig 411 is allowed to make contact with the end face 512 of the intermediate member 51 via the communication passage 400.

The second jig 412 is a member of substantially a tubular shape provided on a radially outer side of the first jig 411. The second jig 412 is linked to the second drive portion 414 (chain line L412 of FIG. 3). The second jig 412 is slidable in the direction of the center axis CA1 of the fuel injection valve 1. The second jig 412 is allowed to make contact with the end face 402 of the adjusting pipe 40 on the side opposite to the injection hole 25.

The detection portion 415 is electrically connected to the first drive portion 413 (chain double-dashed line L415 of FIG. 3). The detection portion 415 detects an urging force of the spring 28 according to an acting force of the spring 28 acting on the first jig 411 when the first drive portion 413 drives the first jig 411 toward the injection hole 25. The detection portion 415 also detects a travel distance of the first jig 411. The detection portion 415 outputs a signal corresponding to magnitude of the detected urging force of the spring 28 and the detected travel distance of the first jig 411 to the calculation portion 416.

The calculation portion 416 is electrically connected to the detection portion 415 (chain double-dashed line L416 of FIG. 3). According to a signal corresponding to the magnitude of the urging force of the spring 28 and the travel distance of the first jig 411 outputted from the detection portion 415, the calculation portion 416 calculates a pipe set position of the adjusting pipe 40 as an adjusting member set position, at which an urging force of the spring 28 reaches a target urging force Fsp3 as a predetermined urging force. The calculation portion 416 outputs a signal corresponding to the pipe set position to the control portion 417.

The control portion 417 is electrically connected to the first drive portion 413, the second drive portion 414, and the calculation portion 416 (chain double-dashed lines L413, L414, L417 of FIG. 3, respectively). The control portion 417 outputs a first control signal to the first drive portion 413 and controls a sliding motion of the first jig 411. The control portion 417 also outputs a signal corresponding to the pipe set position to the second drive portion 414 and controls a sliding motion of the second jig 412.

An adjusting method of an urging force of the spring 28 using the urging force adjusting device 41 will now be described.

Firstly, as shown in FIG. 3, the spring 28 is fit to the fuel injection valve 1 before the fuel introduction pipe 16 is fit.

Subsequently, the intermediate member 51 and the adjusting pipe 40 are pushed into the fixed core 38. The intermediate member 51 having the outer diameter smaller than the inner diameter of the fixed core 38 is freely slidable in the direction of the center axis CA1. The intermediate member 51 inserted into the fixed core 38 is in contact with the second end of the spring 28.

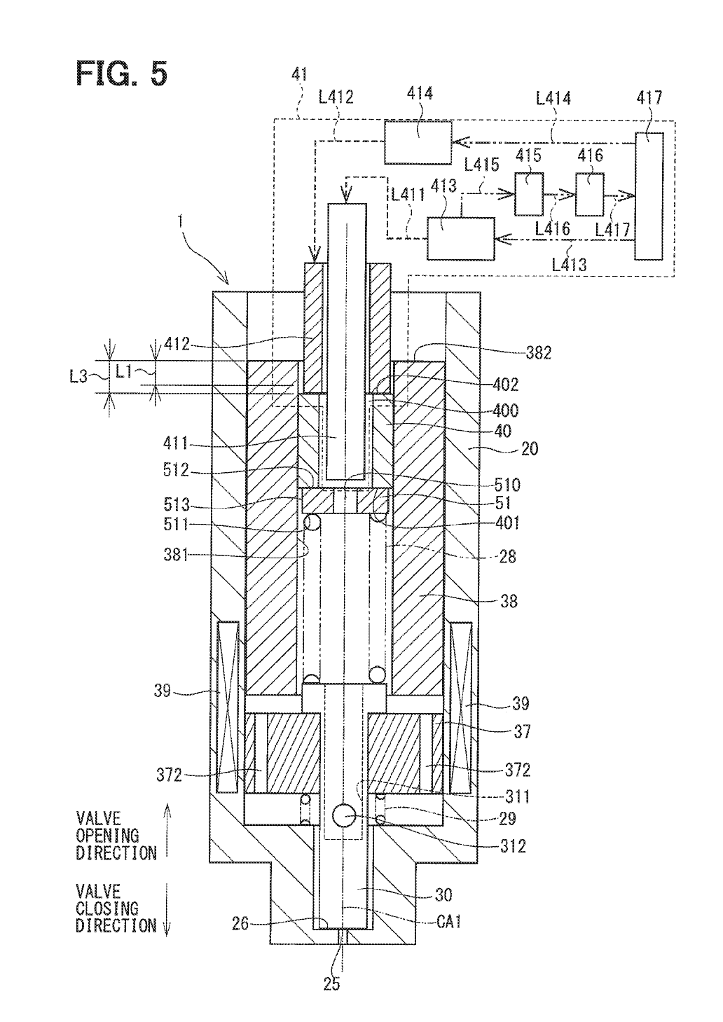

The adjusting pipe 40 having the outer diameter equal to the inner diameter of the fixed core 38 is press-fit in the fixed core 38 when pushed inside by the second jig 412. The first jig 411 remains in contact with the intermediate member 51 until the adjusting pipe 40 pushed inside makes contact with the intermediate member 51 (until the distance L=0 reaches a distance L1 of FIG. 5). A length of the spring 28 in a state as above is a natural length. Naturally, an urging force of the spring 28 detected by the detection portion 415 is zero.

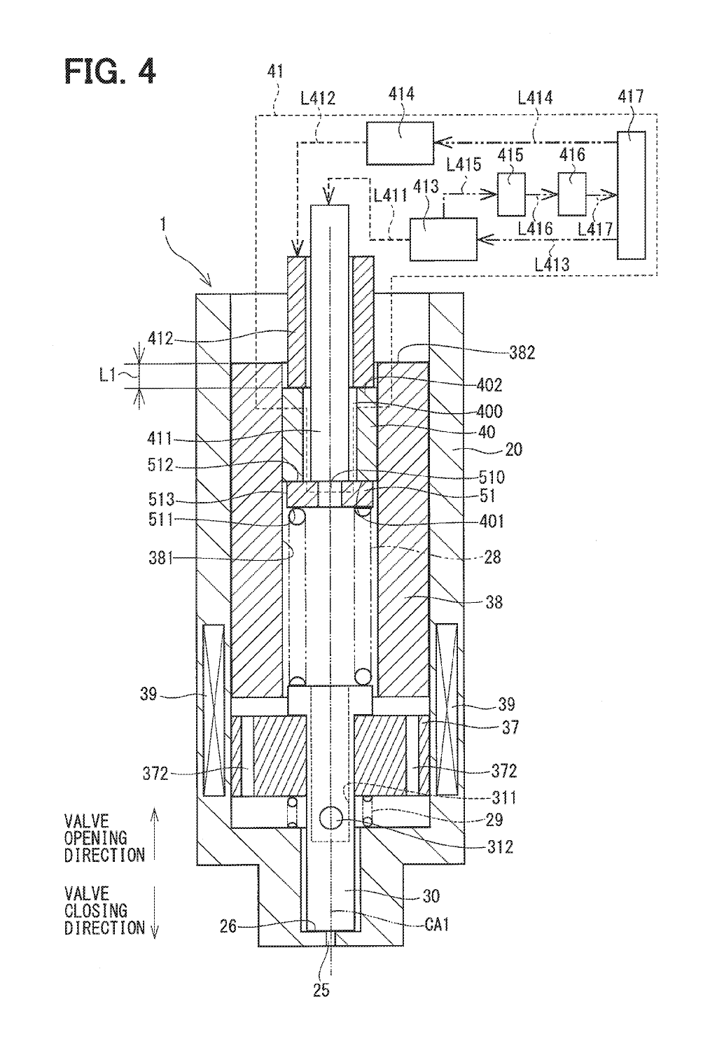

When the distance L reaches the distance L1, the adjusting pipe 40 makes contact with the intermediate member 51 (see FIG. 4). Subsequently, the intermediate member 51 and the adjusting pipe 40 are moved in the valve closing direction, respectively, by the first jig 411 and the second jig 412 while the adjusting pipe 40 and the intermediate member 51 are maintained in contact with each other. The detection portion 415 detects an urging force of the spring 28 according to the distance L.

When the intermediate member 51 and the adjusting pipe 40 are moved in the valve closing direction to increase the distance L that has reached the distance L1, the calculation portion 416 finds out a relationship of the distance L and an urging force Fsp of the spring 28 according to an urging force of the spring 28 detected by the detection portion 415 (a solid line segment FL1 between the distance L1 and a distance L2 of FIG. 6). A distance that the adjusting pipe 40 is allowed to travel until a relationship of the distance L and the urging force Fsp is found out is set to be the distance L2 calculated in advance for an urging force of the spring 28 to reach an urging force Fsp2 smaller than the target urging force Fsp3. Then, the calculation portion 416 calculates a distance L3 from the end face 382 to the end face 402 when an urging force of the spring 28 reaches the target urging force Fsp3 according to the relationship of the distance L and the urging force Fsp found out as above (a dotted line segment FL2 between the distance L2 and the distance L3 of FIG. 6). That is, the pipe set position of the adjusting pipe 40 in the fuel injection valve 1 is a position at which a distance from the end face 382 to the end face 402 reaches the distance L3.

When a signal corresponding to the distance L3 calculated by the calculation portion 416 is outputted to the control portion 417, the control portion 417 controls the second drive portion 414 to push in the second jig 412 in the valve closing direction until a distance from the end face 382 to the end face 402 reaches the distance L3 (see FIG. 5). When a distance from the end face 382 to the end face 402 reaches the distance L3, the adjusting process of an urging force of the spring 28 is ended.

An effect of the fuel injection valve 1 of the first embodiment will now be described according to FIG. 7. In FIG. 7, an abscissa is used for a time Ti from an issuance of a fuel injection start command and an ordinate is used for a fuel injection amount Qi of the fuel injection valve 1. An origin of the abscissa is set to a time when supply of power to the coil 39 is started.

As shown in FIG. 7, the fuel injection valve 1 opens when the needle 30 moves away from the seat 26 with an elapse of a reasonable time after supply of power to the coil 39 is started. A valve opening behavior of the fuel injection valve 1 is determined by a balance between an attraction force between the movable core 37 driving the needle 30 in the valve opening direction and the fixed core 38, and urging forces of the springs 28 and 29 both urging the needle 30. Among the foregoing parameters, an urging force of the spring 28 is determined by the pipe set position of the adjusting pipe 40 press-fit to the fixed core 38.

When the pipe set position of the adjusting pipe 40 varies, a fuel injection start time of the fuel injection valve 1 varies, too. More specifically, when the adjusting pipe 40 is not press-fit sufficiently and located at a shallow pipe set position, that is, at a position relatively close to the fuel introduction pipe 16, an urging force of the spring 28 becomes smaller than the target urging force. Hence, the fuel injection valve 1 starts fuel injection at a time T1 earlier than a time T0 as target fuel injection start timing. A fuel injection amount is indicated by a chain double-dashed line QT1. Conversely, when the adjusting pipe 40 is press-fit deep inside the fixed core 38 and located at a deep pipe set position, that is, at a position close to the needle 30, an urging force of the spring 28 becomes greater than the target urging force. Hence, the fuel injection valve 1 starts fuel injection at a time T2 later than the target time T0. A fuel injection amount is indicated by a chain double-dashed line QT2.

In the fuel injection valve 1 of the first embodiment, the intermediate member 51 capable of detecting an urging force of the spring 28 independently of a press-fit state of the adjusting pipe 40 is provided between the adjusting pipe 40 and the spring 28. When the fuel injection valve 1 is manufactured, a relationship of a position of the adjusting pipe 40 and an urging force of the spring 28 is found out. The pipe set position of the adjusting pipe, at which an urging force of the spring 28 reaches the target urging force, is calculated according to the relationship found out. In the fuel injection valve 1, the adjusting pipe 40 is fixed at the pipe set position thus calculated. Hence, the fuel injection valve 1 is capable of setting an urging force of the spring 28 at a high degree of accuracy. Consequently, a time from the start of a supply of power to the coil 39 to the start of actual fuel injection can be set at a high degree of accuracy.

In a case where multiple fuel injection valves are manufactured, in order to reduce irregularities of fuel injection start timing and a fuel injection amount as are shown in FIG. 7, a position of an adjusting pipe is adjusted by wet adjustment by actually injecting a fluid as with, for example, the adjusting method of a fuel injection device described in Patent Literature 1. Wet adjustment, however, takes a time in the process of adjusting an urging force of a spring because the position is adjusted while a fluid is kept supplied to the fuel injection valve.

By contrast, owing to the capability of setting an urging force of the spring 28 at a high degree of accuracy, the fuel injection valve 1 is capable of adjusting an urging force of the spring 28 to be the target urging force by dry adjustment without having to inject fluid actually. The fuel injection valve 1 is thus capable of cutting a time required to adjust an urging force shorter.

### Second Embodiment

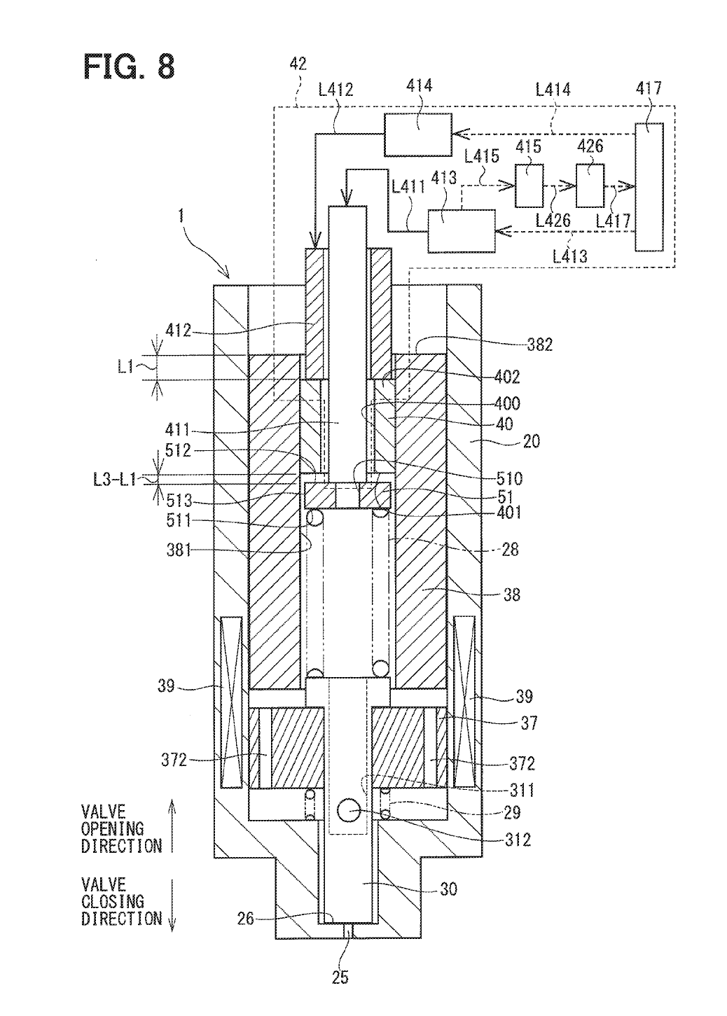

A device for manufacturing a valve device according to a second embodiment of the present disclosure will now be described according to FIG. 8. The second embodiment is different from the first embodiment in a configuration of a device for manufacturing a valve device. Portions substantially same as the portions of the first embodiment above are labelled with same reference numerals and a description is not repeated.

FIG. 8 shows an urging force adjusting device 42 as the device for manufacturing a valve device of the second embodiment. The urging force adjusting device 42 includes the first jig 411, the second jig 412, the first drive portion 413, the second drive portion 414, the detection portion 415, a storage portion 426, and the control portion 417.

The storage portion 426 is electrically connected to the detection portion 415 and the control portion 417 (chain double-dashed lines L426 and L417 of FIG. 8, respectively). The storage portion 426 stores a travel distance of the intermediate member 51 when an urging force of the spring 28 reaches a target urging force Fsp3. The storage portion 426 outputs a signal corresponding to the stored travel distance to the control portion 417.

An adjusting method of an urging force of the spring 28 using the urging force adjusting device 42 will now be described according to FIG. 8.

Firstly, the intermediate member 51 and the adjusting pipe 40 are pushed into the fuel injection valve 1 after the spring 28 is fitted. The adjusting pipe 40 is pressed by the second jig 412 and travels a distance L1 to make contact with the intermediate member 51 which is in contact with the spring 28.

After it is confirmed that the adjusting pipe 40 makes contact with the intermediate member 51, the intermediate member 51 is pushed in toward the injection hole 25 by the first jig 411 while an urging force of the spring 28 is detected by the detection portion 415. The intermediate member 51 is pushed in until an urging force of the spring 28 acting on the intermediate member 51 reaches the target urging force Fsp3 (see FIG. 8).

The storage portion 426 included in the urging force adjusting device 42 stores a travel distance of the intermediate member 51 from a position at which the adjusting pipe 40 makes contact with the intermediate member 51 to an intermediate set position as an intermediate member set position at which an urging force of the spring 28 acting on the intermediate member 51 reaches the target urging force Fsp3, that is, a distance (L3−L1). When the storage portion 426 outputs a signal corresponding to the stored distance (L3−L1) to the control portion 417, the control portion 417 drives the second jig 412 to push in the adjusting pipe 40 by the distance (L3−L1). The adjusting pipe 40 is thus fixed to a pipe set position at which an urging force of the spring 28 reaches the target urging force Fsp3.

In the second embodiment, the urging force adjusting device 42 firstly stores the travel distance (L3−L1) of the intermediate member 51 capable of detecting an urging force of the spring 28, with which an urging force of the spring 28 reaches the target urging force Fsp3, by using the first jig 411. Subsequently, the adjusting pipe 40 is moved by the distance (L3−L1). An urging force of the spring 28 can be thus set at a high degree of accuracy.

### Third Embodiment

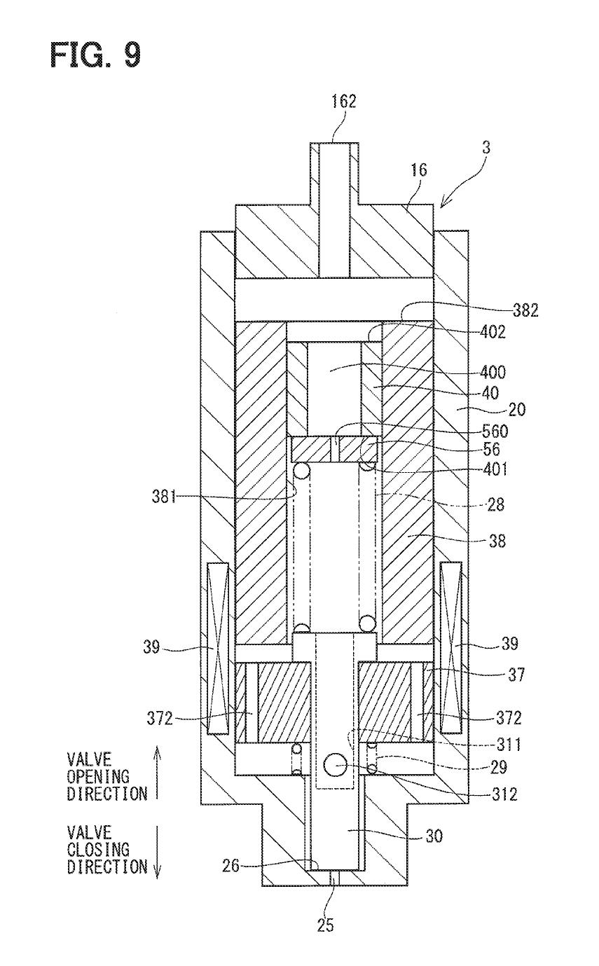

A valve device according to a third embodiment of the present disclosure will now be described according to FIG. 9. The third embodiment is different from the first embodiment above in a shape of an intermediate member. Portions substantially same as the portions of the first embodiment above are labelled with same reference numerals and a description is not repeated.

FIG. 9 shows a fuel injection valve 3 as a valve device of the third embodiment.

An intermediate member 56 included in the fuel injection valve 3 is provided between the adjusting pipe 40 and the spring 28. The intermediate member 56 has a communication hole 560, through which a side opposite to the injection hole 25 and a side of the injection hole 25 communicate with each other. An inner diameter of the communication hole 560 is smaller than the inner diameter of the communication hole 510 provided to the intermediate member 51 of the first embodiment above.

In the fuel injection valve 3, the inner diameter of the communication hole 560 provided to the intermediate member 56 is relatively small. Hence, the communication hole 560 functions as an orifice for a flow of fuel inside the fuel injection valve 3 and a flow of fuel flowing from the communication passage 400 to the side of the injection hole 25 of the intermediate member 56 can be narrower. Pressure pulsation inside the fuel injection valve 3 can be thus reduced.

### Fourth Embodiment

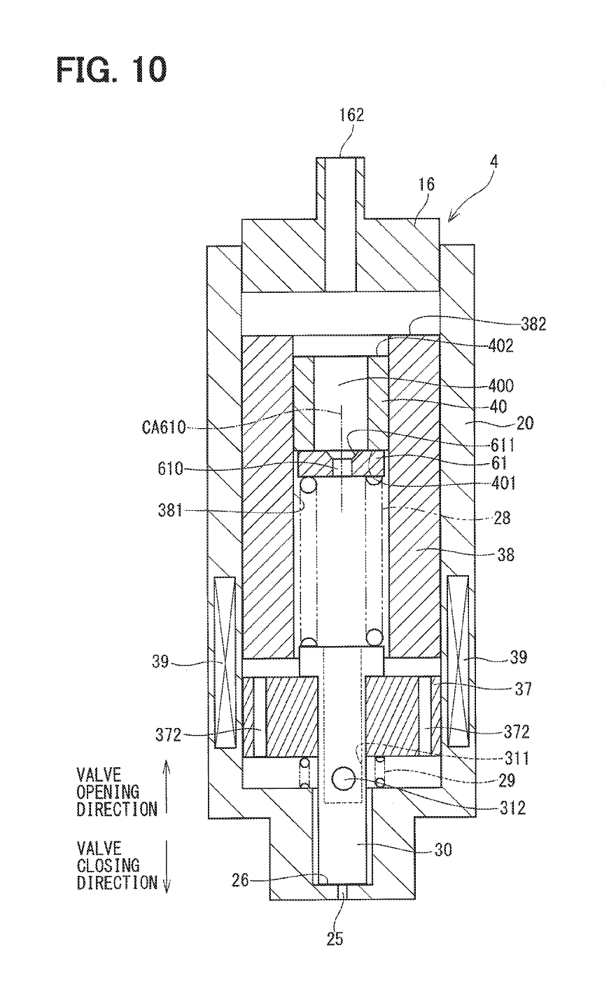

A valve device according to a fourth embodiment of the present disclosure will now be described according to FIG. 10. The fourth embodiment is different from the first embodiment above in a shape of an intermediate member. Portions substantially same as the portions of the first embodiment above are labelled with same reference numerals and a description is not repeated.

FIG. 10 shows a fuel injection valve 4 as the valve device of the fourth embodiment.

An intermediate member 61 included in the fuel injection valve 4 is provided between the adjusting pipe 40 and the spring 28. The intermediate member 61 has a communication hole 610, through which a side opposite to the injection hole 25 and a side of the injection hole 25 communicate with each other. An inner edge of the communication hole 610 on the side opposite to the injection hole 25 has an inner-edge slope 611 formed to be more distant from a center axis CA610 of the communication hole 610 on the side opposite to the injection hole 25 than on the side of the injection hole 25.

In the fuel injection valve 4, fuel introduced into the housing 20 through the introduction port 162 flows from the side where the inner-edge slope 611 is present toward the injection hole 25. The inner-edge slope 611 allows fuel to smoothly flow into the communication hole 610. Hence, resistance of fuel acting on the intermediate member 61 is reduced, which can in turn prevent the intermediate member 61 from undergoing displacement toward the injection hole 25. Consequently, a variance in urging force of the spring 28 caused by a flow of fuel can be prevented.

### Fifth Embodiment

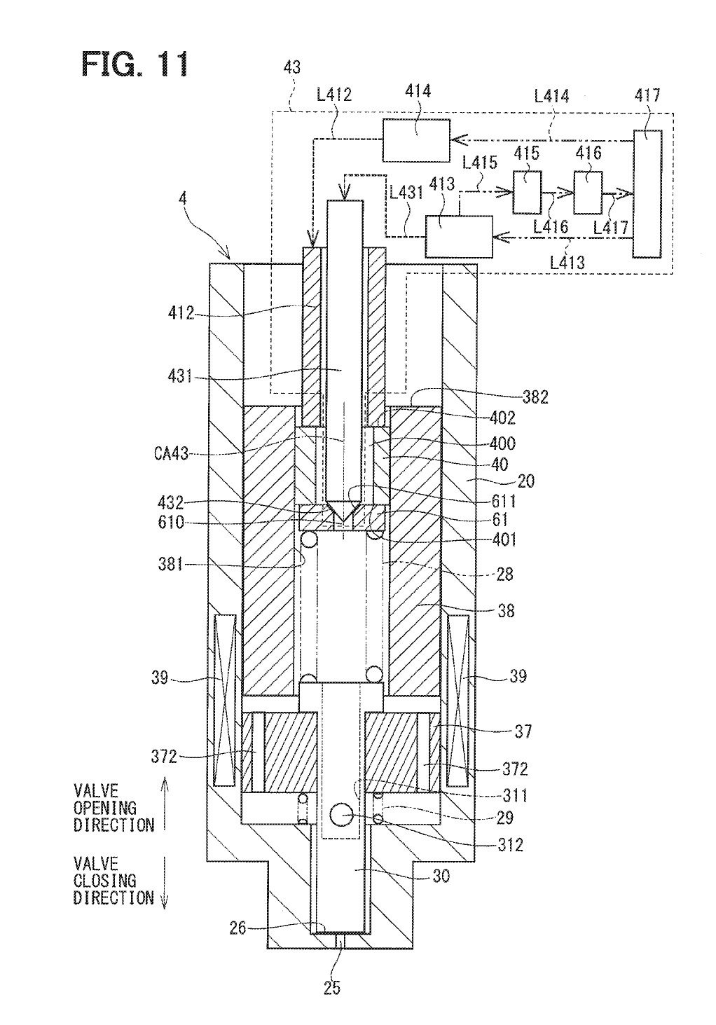

A device for manufacturing a valve device according to a fifth embodiment of the present disclosure will now be described according to FIG. 11. The fifth embodiment is different from the fourth embodiment above in a shape of a first jig. Portions substantially same as the portions of the fourth embodiment above are labelled with same reference numerals and a description is not repeated.

FIG. 11 shows an urging force adjusting device 43 as the device for manufacturing a valve device of the fifth embodiment. The urging force adjusting device 43 includes a first jig 431, the second jig 412, the first drive portion 413 driving the first jig 431, the second drive portion 414, the detection portion 415, the calculation portion 416, and the control portion 417.

The first jig 431 is formed in substantially a rod shape. The first jig 431 is linked to the first drive portion 413 (chain line L431 of FIG. 11). The first jig 431 has a tip-end slope 432 in an outer edge at an end allowed to make contact with an intermediate member 61. The tip-end slope 432 is formed to be more distant from a center axis CA43 of the first jig 431 on a side opposite to the side where the tip-end slope 432 makes contact with the intermediate member 61 than on a side where the tip-end slope 432 makes contact with the intermediate member 61.

In the fifth embodiment, the tip-end slope 432 provided to the first jig 431 is allowed to make contact with the inner-edge slope 611 of the intermediate member 61. Hence, the first jig 431 can be readily centered on the intermediate member 61. Consequently, an urging force of the spring 28 can be set at a higher degree of accuracy.

### Sixth Embodiment

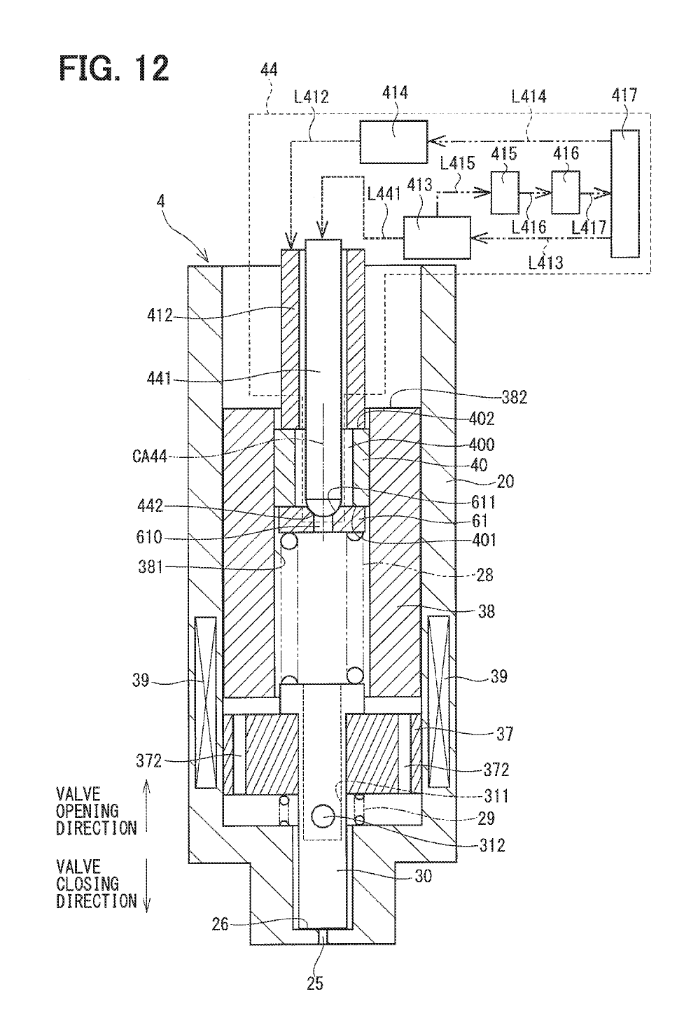

A device for manufacturing a valve device according to a sixth embodiment of the present disclosure will now be described according to FIG. 12. The sixth embodiment is different from the fourth embodiment above in a shape of a first jig. Portions substantially same as the portions of the fourth embodiment above are labelled with same reference numerals and a description is not repeated.

FIG. 12 shows an urging force adjusting device 44 as the device for manufacturing a valve device of the sixth embodiment. The urging force adjusting device 44 includes a first jig 441, the second jig 412, the first drive portion 413 driving the first jig 441, the second drive portion 414, the detection portion 415, the calculation portion 416, and the control portion 417.

The first jig 441 is formed in substantially a rod shape. The first jig 441 is linked to the first drive portion 413 (chain line L441 of FIG. 12). The first jig 441 has an outer wall 442 of a spherical shape at an end allowed to make contact with the intermediate member 61.

In the sixth embodiment, the outer wall 442 of the first jig 431 is allowed to make contact with the inner-edge slope 611 of the intermediate member 61. Hence, the first jig 441 can be readily centered on the intermediate member 61. Consequently, an urging force of the spring 28 can be set at a further higher degree of accuracy.

### Seventh Embodiment

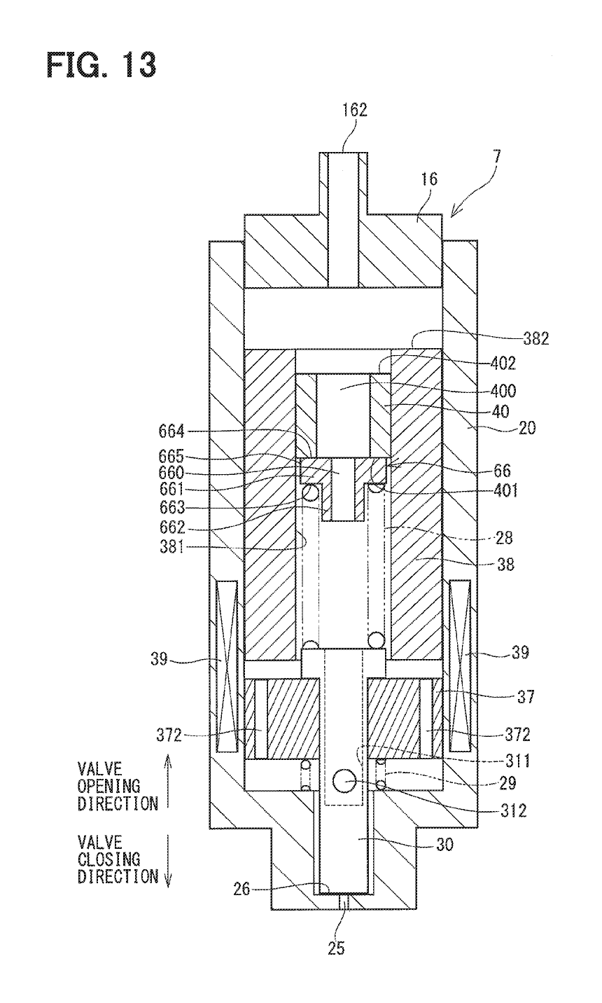

A valve device according to a seventh embodiment of the present disclosure will now be described according to FIG. 13. The seventh embodiment is different from the first embodiment above in a shape of an intermediate member. Portions substantially same as the first embodiment above are labelled with same reference numerals and a description is not repeated.

FIG. 13 shows a fuel injection valve 7 as the valve device of the seventh embodiment.

An intermediate member 66 included in the fuel injection valve 7 includes a contact portion 661 and a protrusion 662 as a first protrusion. The intermediate member 66 has a communication hole 660 penetrating through the contact portion 661 and the protrusion 662, through which a side of the intermediate member 66 opposite to the injection hole 25 and a side of the injection hole 25 communicate with each other.

The contact portion 661 is provided between the adjusting pipe 40 and the spring 28. At an end face 663 on the side of the injection hole 25, the contact portion 661 is in contact with a second end of the spring 28. At an end face 664 on the side opposite to the injection hole 25, the contact portion 661 is in contact with the end face 401 of the adjusting pipe 40. A clearance is provided between an outer wall 665 on a radially outer side of the contact portion 661 and the inner wall 381 on a radially inner side of the fixed core 38.

The protrusion 662 is provided to protrude from the end face 663 of the contact portion 661 toward the injection hole 25. The protrusion 662 is inserted into the second end of the spring 28 which is in contact with the contact portion 661.

In the fuel injection valve 7, the protrusion 662 inserted into the second end of the spring 28 is capable of guiding stretching and contracting motion of the spring 28. Consequently, an urging force of the spring 28 can be stabilized.

### Eighth Embodiment

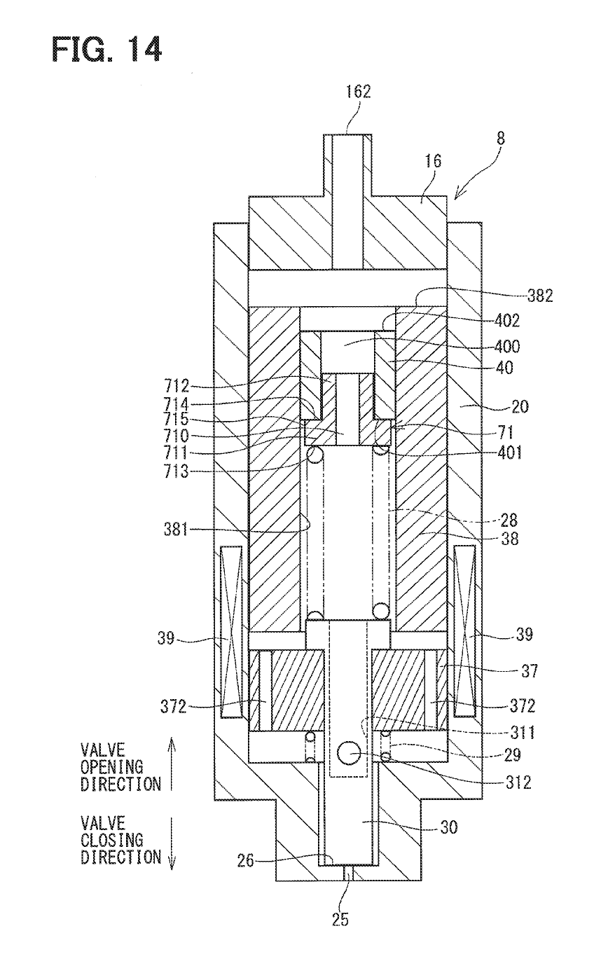

A valve device according to an eighth embodiment of the present disclosure will now be described according to FIG. 14. The eighth embodiment is different from the first embodiment above in a shape of an intermediate member. Portions substantially same as the portions of the first embodiment above are labelled with same reference numerals and a description is not repeated.

FIG. 14 shows a fuel injection valve 8 as the valve device of the eighth embodiment.

An intermediate member 71 included in the fuel injection valve 8 includes a contact portion 711 and a protrusion 712 as a second protrusion. The intermediate member 71 has a communication hole 710 penetrating through the contact portion 711 and the protrusion 712, through which a side of the intermediate member 71 opposite to the injection hole 25 and a side of the injection hole 25 communicate with each other.

The contact portion 711 is provided between the adjusting pipe 40 and the spring 28. At an end face 713 on the side of the injection hole 25, the contact portion 711 is in contact with a second end of the spring 28. At an end face 714 on the side opposite to the injection hole 25, the contact portion 711 is in contact with the end face 401 of the adjusting pipe 40 on the side of the injection hole 25. A clearance is provided between an outer wall 715 on a radially outer side of the contact portion 711 and the inner wall 381 on a radially inner side of the fixed core 38.

The protrusion 712 is provided to protrude from the end face 714 of the contact portion 711 oppositely to the injection hole 25. The protrusion 712 is inserted into the communication passage 400 of the adjusting pipe 40.

In the fuel injection valve 8, the adjusting pipe 40 and the intermediate member 71 can be positioned to each other in a radial direction by the protrusion 712 inserted into the communication passage 400. Consequently, a position of the adjusting pipe 40 in the radial direction relative to the intermediate member 71 can be stabilized.

### Ninth Embodiment

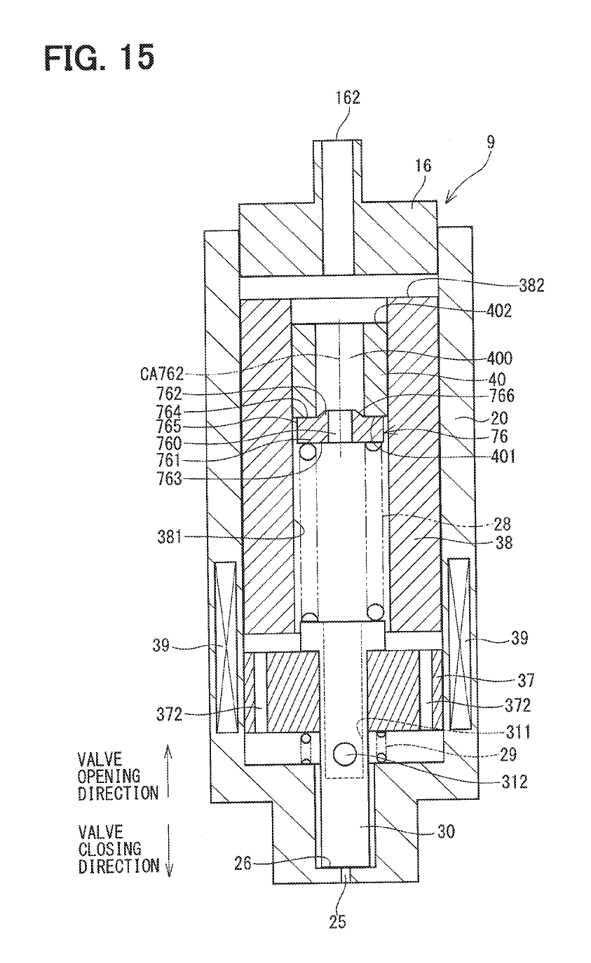

A valve device according to a ninth embodiment of the present disclosure will now be described according to FIG. 15. The ninth embodiment is different from the first embodiment above in a shape of an intermediate member. Portions substantially same as the portions of the first embodiment above are labelled with same reference numerals and a description is not repeated.

FIG. 15 shows a fuel injection valve 9 as the valve device of the ninth embodiment.

An intermediate member 76 included in the fuel injection valve 9 includes a contact portion 761 and a protrusion 762 as a second protrusion. The intermediate member 76 has a communication hole 760 penetrating through the contact portion 761 and the protrusion 762, through which a side of the intermediate member 76 opposite to the injection hole 25 and a side of the injection hole 25 communicate with each other.

The contact portion 761 is provided between the adjusting pipe 40 and the spring 28. At an end face 763 on the side of the injection hole 25, the contact portion 761 is in contact with a second end of the spring 28. At an end face 764 on the side opposite to the injection hole 25, the contact portion 761 is in contact with the end face 401 of the adjusting pipe 40 on the side of the injection hole 25. A clearance is provided between an outer wall 765 on a radially outer side of the contact portion 761 and the inner wall 381 on a radially inner side of the fixed core 38.

The protrusion 762 is provided to protrude from the end face 764 of the contact portion 761 oppositely to the injection hole 25. An outer edge of the protrusion 762 on the side opposite to the injection hole 25 has an outer-edge slope 766 which comes closer to a center axis CA762 of the protrusion 762 on the side opposite to the injection hole 25 than on the side of the injection hole 25. The protrusion 762 is located in the communication passage 400 of the adjusting pipe 40.

In the fuel injection valve 9, when the adjusting pipe 40 and the intermediate member 76 are positioned to each other, the outer-edge slope 766 and an inner edge of the adjusting pipe 40 on the side of the injection hole 25 make contact with each other, which enables positioning in a radial direction in a reliable manner. Consequently, a position of the adjusting pipe 40 relative to the intermediate member 76 can be stabilized.

### Tenth Embodiment

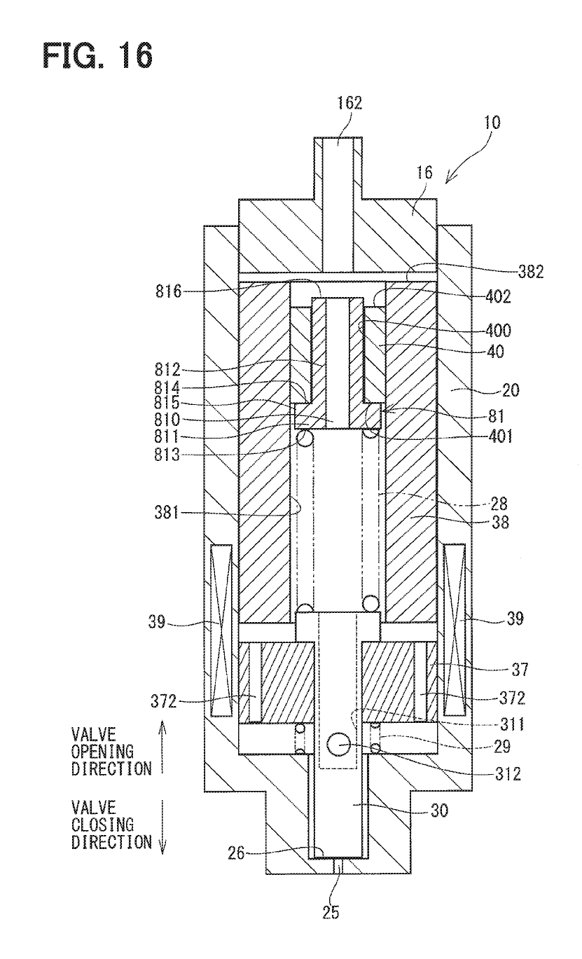

A valve device and a device for manufacturing a valve device according to a tenth embodiment of the present disclosure will now be described according to FIGS. 16 to 19. The tenth embodiment is different from the first embodiment above in shapes of an intermediate member, a first jig, and a second jig. Portions substantially same as the portions of the first embodiment above are labelled with same reference numerals and a description is not repeated.

FIG. 16 shows a fuel injection valve 10 as the valve device of the tenth embodiment.

An intermediate member 81 included in the fuel injection valve 10 includes a contact portion 811 and a protrusion 812 as a second protrusion. The intermediate member 81 has a communication hole 810 penetrating through the contact portion 811 and the protrusion 812, through which a side of the intermediate member 81 opposite to the injection hole 25 and a side of the injection hole 25 communicate with each other.

The contact portion 811 is provided between the adjusting pipe 40 and the spring 28. At an end face 813 on the side of the injection hole 25, the contact portion 811 is in contact with a second end of the spring 28. At an end face 814 on the side opposite to the injection hole 25, the contact portion 811 is in contact with the end face 401 of the adjusting pipe 40. A clearance is provided between an outer wall 815 on a radially outer side of the contact portion 811 and the inner wall 381 on a radially inner side of the fixed core 38.

The protrusion 812 is provided to protrude from the end face 814 of the contact portion 811 oppositely to the injection hole 25. The protrusion 812 is passed through the communication passage 400 of the adjusting pipe 40. The protrusion 812 is provided to protrude from the end face 402 of the adjusting pipe 40 toward the fuel introduction pipe 16.

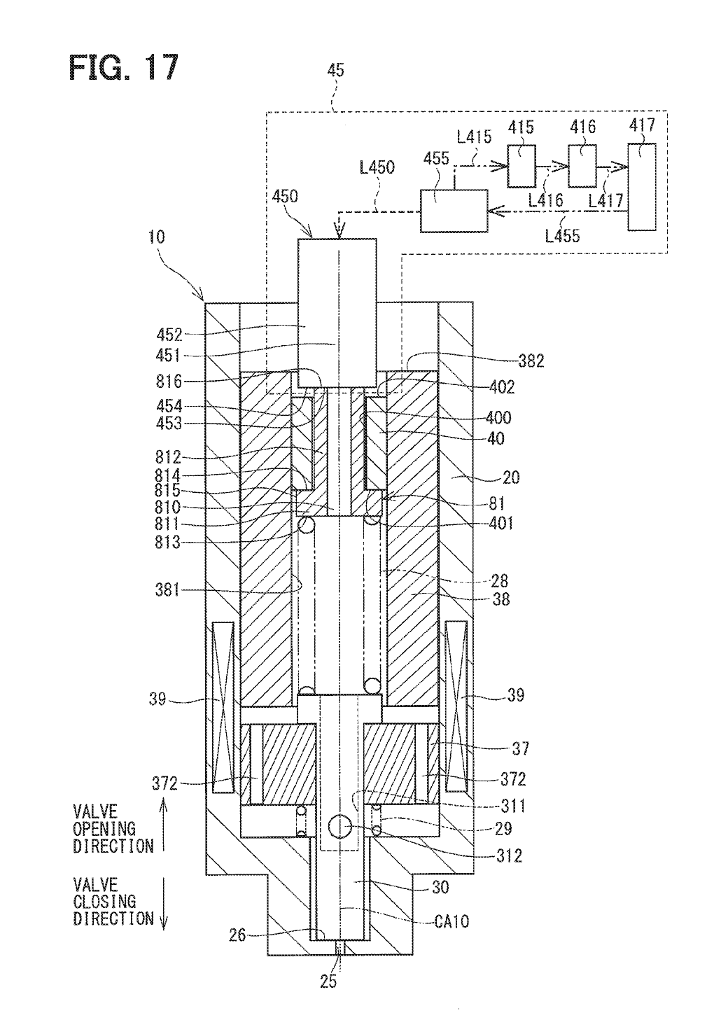

An adjusting method of an urging force of the spring 28 in a manufacturing method of the fuel injection valve 10 will now be described according to FIGS. 17 to 19. An urging force adjusting device 45 adjusting an urging force of the spring 28 included in the fuel injection valve 10 includes a common jig 450, a common drive portion 455 driving the common jig 450, the detection portion 415, the calculation portion 416, and the control portion 417 controlling the common drive portion 455.

The common jig 450 includes a first portion 451 as a first jig and a second portion 452 as a second jig. In short, the common jig 450 includes the first jig and the second jig formed integrally. The first portion 151 is allowed to make contact with an end face 816 of the protrusion 812 on the side opposite to the injection hole 25. The second portion 452 is provided on a radially outer side of the first portion 451 and allowed to make contact with the end face 402 of the adjusting pipe 40. An end face 453 of the first portion 451 on the side of the injection hole 25 and an end face 454 of the second portion 452 on the side of the injection hole 25 are provided to be flush with each other.

The common drive portion 455 is linked to the common jig 450 (chain line L450 of FIGS. 17 to 19). The common drive portion 455 is also electrically connected to the control portion 417 (chain double-dashed line L455 of FIGS. 17 to 19). The common drive portion 455 drives the common jig 450 to slide in a direction of a center axis CA10 of the fuel injection valve 10 according to a control signal outputted from the control portion 417.

An adjusting method of an urging force of the spring 28 using the urging force adjusting device 45 will now be described.

Firstly, after the adjusting pipe 40 is pushed into the fixed core 38 to a predetermined position, the common jig 450 is brought into contact with the end face 816 of the protrusion 812 (see FIG. 17).

Subsequently, the intermediate member 81 is pushed toward the injection hole 25 by the common jig 450. The calculation portion 416 finds out a relationship of a travel distance of the intermediate member 81 and an urging force Fsp of the spring 28 according to an urging force of the spring 28 detected by the detection portion 415 before the common jig 450 makes contact with the adjusting pipe 40. The calculation portion 416 calculates a distance L3 from the end face 382 to the end face 402 when an urging force of the spring 28 reaches a target urging force Fsp3 according to the relationship of the travel distance of the intermediate member 81 and the urging force Fsp found out as above.

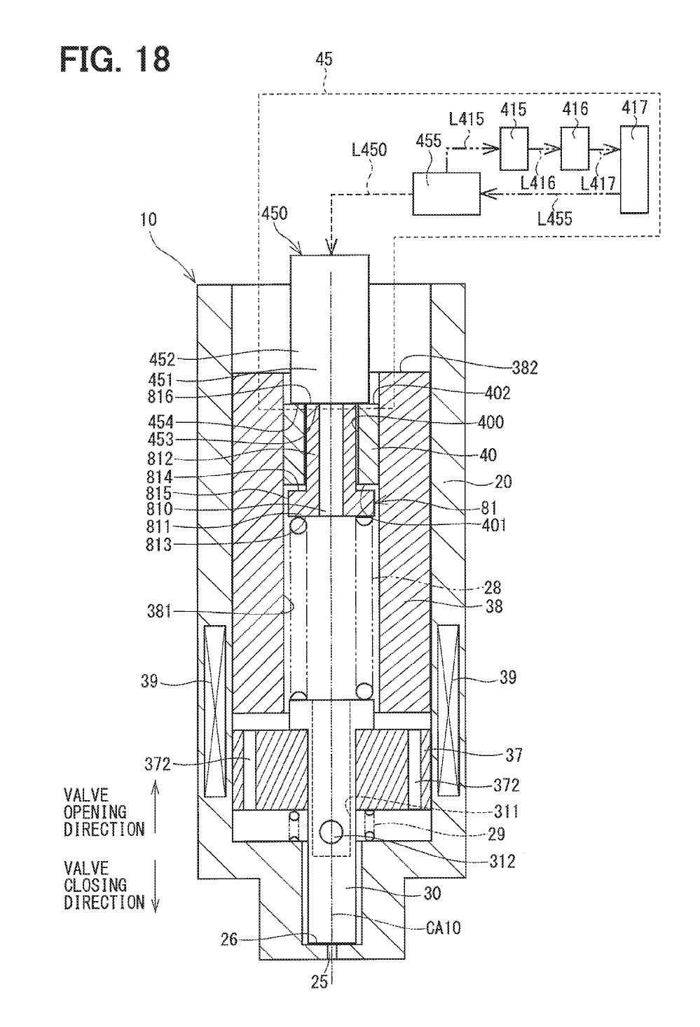

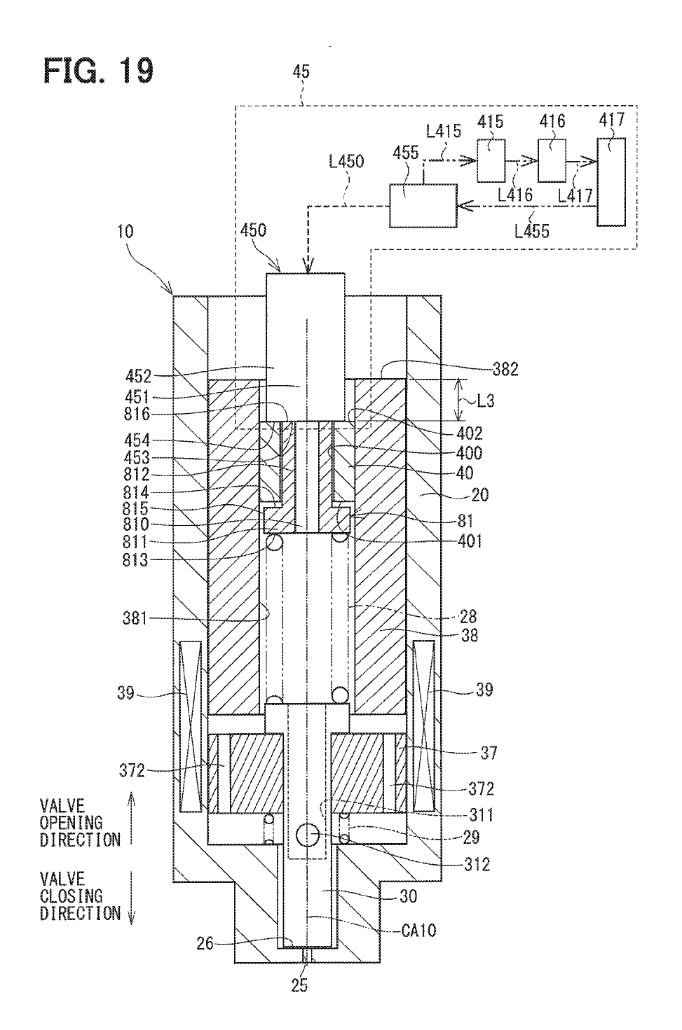

When the common jig 450 and the adjusting pipe 40 make contact with each other (see FIG. 18), the control portion 417 controls the common drive portion 455 to push the common jig 450 further toward the injection hole 25 for a distance from the end face 382 to the end face 402 to reach the distance L3. When a distance from the end face 382 to the end face 402 reaches the distance L3, an adjusting process of an urging force of the spring 28 is ended (see FIG. 19). The intermediate member 81 is pushed in for an urging force of the spring 28 to exceed the urging force Fsp3. However, a clearance is provided between the contact portion 811 and the adjusting pipe 40 and between the intermediate member 81 and the fixed core 38. Hence, when pressing by the common jig 450 is released, the intermediate member 81 moves in a valve opening direction to make contact with the adjusting pipe 40 due to an urging force of the spring 28.

In the tenth embodiment, the urging force adjusting device 45 is capable of setting the adjusting pipe 40 and the intermediate member 81 for an urging force of the spring 28 to reach the target urging force Fsp3 by pushing the adjusting pipe 40 and the intermediate member 81 into the fixed core 38 using the single common jig 450. Consequently, the configuration of the urging force adjusting device 45 can be simpler.

### Eleventh Embodiment

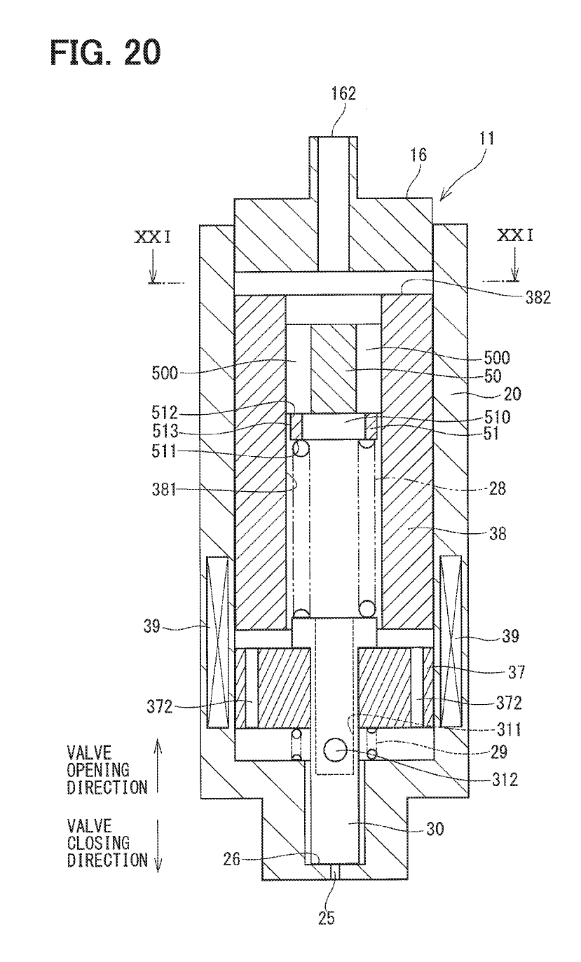

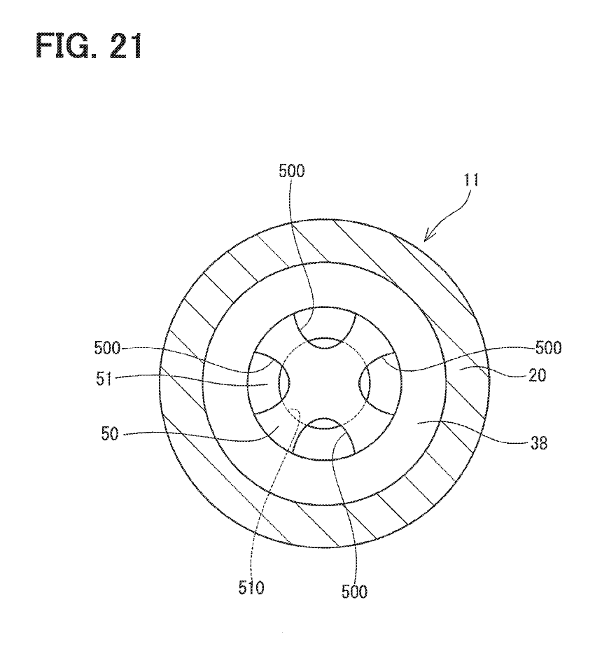

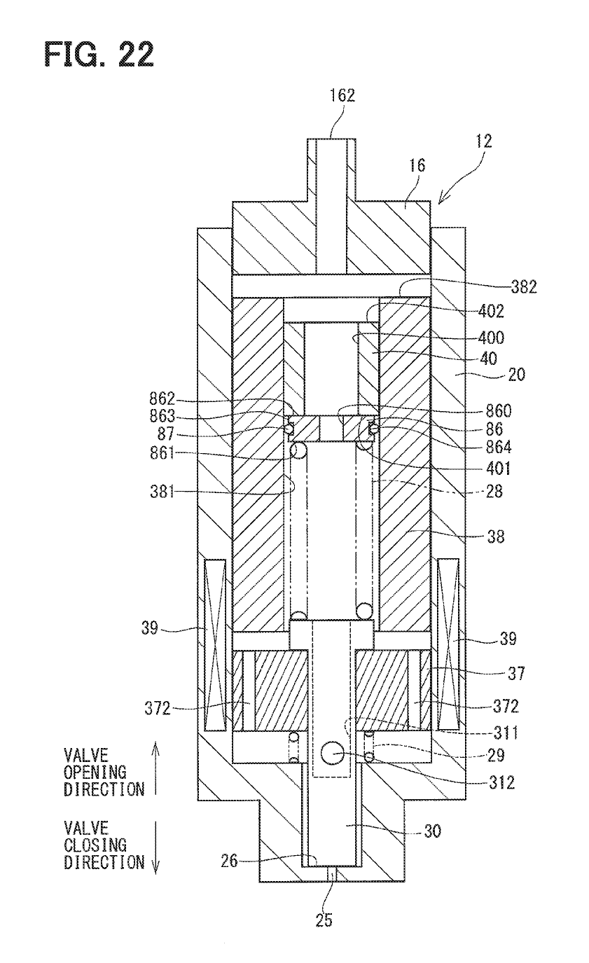

A valve device according to an eleventh embodiment of the present disclosure will now be described according to FIGS. 20 and 21. The eleventh embodiment is different from the first embodiment above in a shape of an adjusting pipe. Portions substantially same as the portions of the first embodiment above are labelled with same reference numerals and a description is not repeated.

FIG. 20 shows a fuel injection valve 11 as the valve device of the eleventh embodiment.

An adjusting pipe 50 included in the fuel injection valve 11 has multiple communication passages 500 in an outer edge. As shown in FIG. 21, the communication passages 500 are formed by cutting out the outer edge radially inward. The communication passages 500 are provided at regular intervals in a circumferential direction of the adjusting pipe 50. In the eleventh embodiment, the adjusting pipe 50 has four communication passages 500. Through the communication passages 500, a side of the adjusting pipe 50 opposite to the injection hole 25 and a side of the injection hole 25 communicate with each other.

In the fuel injection valve 11, when an urging force of the spring 28 is adjusted by using the urging force adjusting device 41, the first jig 411 is allowed to make contact with the intermediate member 51 by exploiting the communication passages 500. Consequently, an urging force of the spring 28 can be set at a high degree of accuracy.

### Twelfth Embodiment

A valve device according to a twelfth embodiment of the present disclosure will now be described according to FIG. 22. The twelfth embodiment is different from the first embodiment above in that an O-ring is provided on a radially outer side of an intermediate member. Portions substantially same as the portions of the first embodiment above are labelled with same reference numerals and a description is not repeated.

FIG. 22 shows a fuel injection valve 12 as the valve device of the twelfth embodiment.

An intermediate member 86 included in the fuel injection valve 12 is provided between the adjusting pipe 40 and the spring 28. At an end face 861 on a side of the injection hole 25, the intermediate member 86 is in contact with a second end of the spring 28. At an end face 862 on a side opposite to the injection hole 25, the intermediate member 86 is in contact with the end face 401 of the adjusting pipe 40 on the side of the injection hole 25. The intermediate member 86 has a communication hole 860, through which the side opposite to the injection hole 25 and the side of the injection hole 25 communicate with each other.

An outer wall 863 on a radially outer side of the intermediate member 86 has a groove 864 that recesses radially. The groove 864 is provided with an O-ring 87 as a swelling member. The O-ring 87 defines a clearance with the inner wall 381 of the fixed core 38 unless touched with fuel. Once the O-ring 87 is touched with fuel, the O-ring 87 swells and makes contact with the inner wall 381. The intermediate member 86 is thus made immovable relative to the fixed core 38.

When the fuel injection valve 12 is manufactured, an urging force of the spring 28 is adjusted by using the urging force adjusting device 41. Herein, an urging force of the spring 28 is adjusted by dry adjustment without flowing fuel, and no fuel flows inside the injection fuel valve 12. Hence, because the O-ring 87 is not touched with fuel, a clearance is provided between the O-ring 87 and the fixed core 38, and the intermediate member 86 is movable relative to the fixed core 38. In the fuel injection valve 12, an urging force of the spring 28 can be detected at a high degree of accuracy via the intermediate member 86 which is movable relative to the fixed core 38.

When fuel is supplied into the fuel injection valve 12 after an urging force of the spring 28 is adjusted, the O-ring 87 swells and makes the intermediate member 86 immovable relative to the fixed core 38. Hence, the intermediate member 86 can be prevented from moving due to resistance of fuel introduced from the fuel introduction pipe 16. Consequently, the fuel injection valve 12 is not only capable of setting an urging force of the spring 28 at a high degree of accuracy during manufacturing, but also capable of preventing a variance in urging force of the spring 28 due to a flow of fuel in practical use.

### Thirteenth Embodiment

A valve device and a method for manufacturing a valve device according to a thirteenth embodiment of the present disclosure will now be described. The thirteenth embodiment is different from the first embodiment above in a material of an intermediate member and an adjusting method of an urging force of a spring. Portions substantially same as the portions of the first embodiment above are labelled with same reference numerals and a description is not repeated.

The intermediate member 51 included in the fuel injection valve of the thirteenth embodiment is made of a material having a large volume change rate in response to a temperature change.

When an urging force of the spring 28 included in the fuel injection valve is adjusted, the intermediate member 51 is first cooled to contract. In such a state, the intermediate member 51 becomes movable relative to the fixed core 38. Hence, an urging force of the spring 28 can be detected at a high degree of accuracy via the intermediate member 51.

When a temperature of the intermediate member 51 is restored to room temperature after an urging force of the spring 28 is adjusted, the intermediate member 51 expands and becomes immovable relative to the fixed core 38. Hence, the intermediate member 51 can be prevented from moving due to resistance of fuel introduced from the fuel introduction pipe 16. The intermediate member 51 also becomes movable relative to the fixed core 38 when a temperature falls in an environment where the fuel injection valve is used. The fuel injection valve of the thirteenth embodiment is thus not only capable of setting an urging force of the spring 28 at a high degree of accuracy during manufacturing, but also capable of preventing a variance in urging force of the spring 28 caused by a flow of fuel in practical use.

### Fourteenth Embodiment

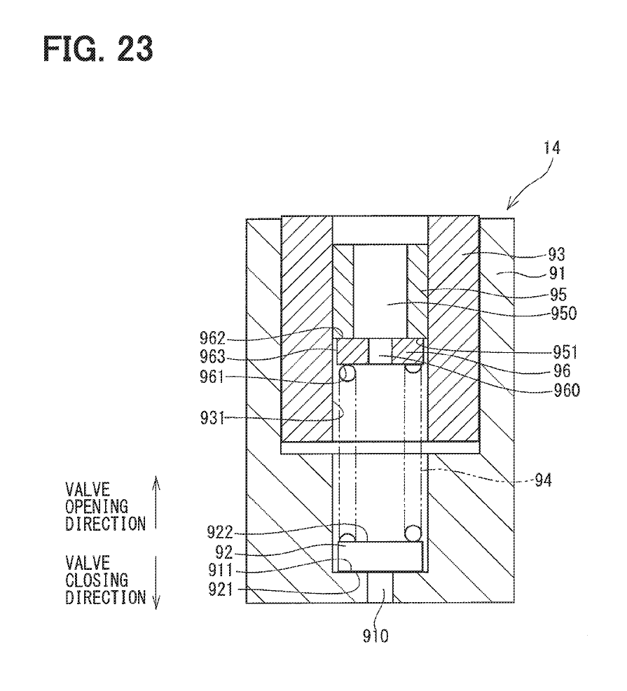

A valve device according to a fourteenth embodiment of the present disclosure will now be described according to FIG. 23. The fourteenth embodiment is different from the first embodiment above in that a drive portion driving a needle in a valve opening direction is omitted. Portions substantially same as the portions of the first embodiment above are labelled with same reference numerals and a description is not repeated.

FIG. 23 shows a valve device 14 of the fourteenth embodiment. The valve device 14 is, for example, so-called a relief valve which allows a high-pressure fluid to flow from an unillustrated high-pressure passage for a high-pressure fluid to an unillustrated low-pressure passage for a low-pressure fluid while inhibiting a flow of a fluid from the low-pressure passage to the high-pressure passage. The valve device 14 includes a housing 91 as a valve housing, a valve member 92, a tubular member 93, a spring 94 as an urging member, an adjusting pipe 95 as an adjusting member, and an intermediate member 96. FIG. 23 shows a valve opening direction in which the valve member 92 moves away from a seat 911 and a valve closing direction in which the valve member 92 comes into contact with the seat 911.

The housing 91 is formed in a tubular shape with a closed bottom. At the bottom, the housing 91 has a hole 910, through which an exterior and an interior of the housing 91 communicate with each other. The seat 911 is provided on a periphery of the hole 910 on an inner side.

The valve member 92 is a member of substantially a disc shape and is slidable in the housing 91. At an end face 921 on a side of the hole 910, the valve member 92 is allowed to make contact with the seat 911.

The tubular member 93 is provided to an inner wall of the housing 91. The tubular member 93 is provided immovably relative to the housing 91.

The spring 94 is provided in such a manner that a first end makes contact with an end face 922 of the valve member 92 on a side opposite to the hole 910. A second end of the spring 94 is in contact with the intermediate member 96. The spring 94 has an axially stretching force. Hence, the spring 94 urges the valve member 92 in a direction to the seat 911, that is, in the valve closing direction.

The adjusting pipe 95 is a tubular member. The adjusting pipe 95 is formed to have an outer diameter equal to an inner diameter of the tubular member 93. The adjusting pipe 95 is press-fit and fixed inside the tubular member 93. The adjusting pipe 95 has a communication passage 950, through which a side of the adjusting pipe 95 opposite to the hole 910 and a side of the hole 910 communicate with each other.

The intermediate member 96 is provided between the adjusting pipe 95 and the spring 94. At an end face 961 on the side of the hole 910, the intermediate member 96 is in contact with the second end of the spring 94. At an end face 962 on the side opposite to the hole 910, the intermediate member 96 is in contact with an end face 951 of the adjusting pipe 95 on the side of the hole 910. A clearance is provided between an outer wall 963 on a radially outer side of the intermediate member 96 and an inner wall 931 on a radially inner side of the tubular member 93. Hence, the intermediate member 96 is movable relative to the tubular member 93. The intermediate member 96 has a communication hole 960, through which a side opposite to the hole 910 and a side of the hole 910 communicate with each other.

The valve device 14 opens according to a relationship as to whether an urging force of the spring 94 is small or large for a difference between a pressure of a high-pressure fluid flowing a high-pressure passage and a pressure of a low-pressure fluid flowing a low-pressure passage. An urging force of the spring 94 is detected via the intermediate member 96 when the valve device 14 is manufactured. A pipe set position of the adjusting pipe 95 when an urging force of the spring 94 reaches a target urging force is calculated according to a detection result. The adjusting pipe 95 is moved to and fixed at the calculated pipe set position. Consequently, the valve device 14 is capable of setting an urging force of the spring 94 at a high degree of accuracy.

### Fifteenth Embodiment

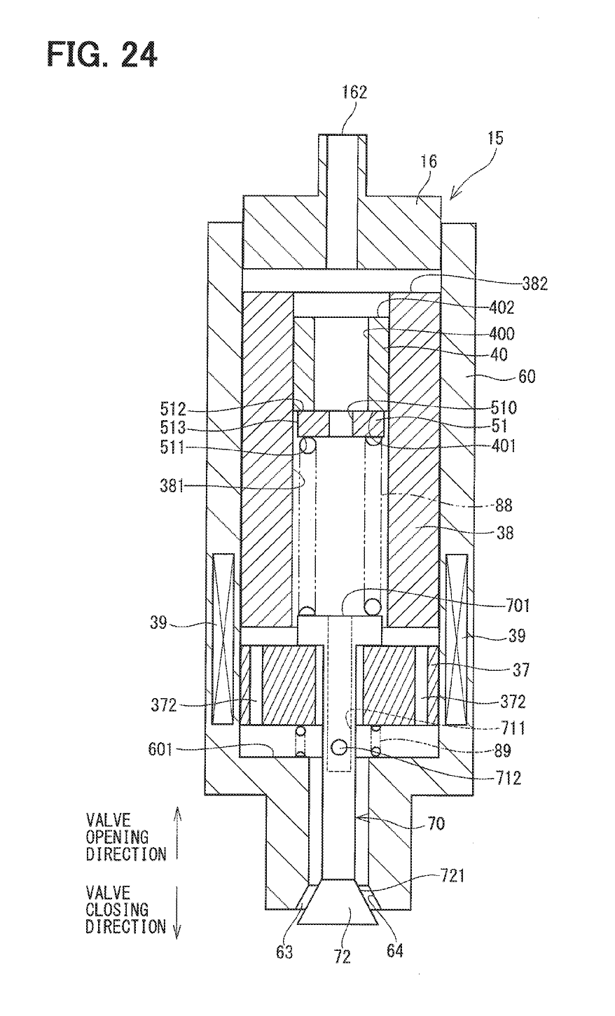

A valve device according to a fifteenth embodiment of the present disclosure will now be described according to FIG. 24. The fifteenth embodiment is different from the first embodiment above in a direction in which a needle moves when the valve device opens. Portions substantially same as the portions of the first embodiment above are labelled with same reference numerals and a description is not repeated.

FIG. 24 shows a valve device 15 of the fifteenth embodiment. The valve device 15 is so-called an outward opening valve. The valve device 15 includes a housing 60 as a valve housing, a needle 70 as a valve member, the movable core 37, the fixed core 38, the coil 39, springs 88 and 89 as an urging member, the adjusting pipe 40, and the intermediate member 51.

The housing 60 is formed in a tubular shape with a closed bottom. At the bottom, the housing 60 has a hole 63, through which an interior and an exterior of the housing 60 communicate with each other. As shown in FIG. 24, the hole 63 is formed in such a manner that an inner diameter increases from the interior to the exterior of the housing 60. A seat 64 is provided to an inner wall where the hole 63 is provided.

The needle 70 includes the shaft portion 31, a seal portion 72, and the flange portion 33. The shaft portion 31, the seal portion 72, and the flange portion 33 are formed integrally.

The seal portion 72 is formed in substantially a truncated conical shape and provided at an end of the shaft portion 31 on a side of the hole 63. A conical surface 721 of the seal portion 72 is allowed to make contact with the seat 64. The needle 70 opens the hole 63 when the conical surface 721 moves away from the seat 64 and closes the hole 63 when the conical surface 721 makes contact with the seat 64 to open and close communication between the interior and the exterior of the housing 60.

The spring 88 is provided in such a manner that a first end makes contact with an end face 701 of the needle 70 on a side opposite to the hole 63. A second end of the spring 88 is in contact with the end face 511 of the intermediate member 51. The spring 88 has an axially stretching force.

Hence, the spring 88 urges the needle 70 together with the movable core 37 in a valve opening direction.

The spring 89 is provided in such a manner that a first end makes contact with an end face of the movable core 37 on the side of the hole 63. A second end of the spring 89 is in contact with an inner wall 601 of the housing 60. The spring 89 has an axially stretching force. The spring 89 urges the movable core 37 together with the needle 70 in a valve closing direction.

When power is supplied to the coil 39, the movable core 37 is attracted toward the fixed core 38 against a difference between an urging force of the spring 88 and an urging force of the spring 89. The needle 70 thus moves in the valve closing direction. Hence, the conical surface 721 of the needle 70 makes contact with the seat 64 and the valve device 15 closes. The valve device 15 is so-called a normally-open valve device which maintains a valve-opening state by a difference between an urging force of the spring 88 and an urging force of the spring 89 unless power is supplied to the coil 39.

When the valve device 15 is manufactured, an urging force of the spring 88 is detected via the intermediate member 51, A pipe set position of the adjusting pipe 40 when an urging force of the spring 88 reaches a target urging force is calculated according to a detection result. The adjusting pipe 40 is moved to and fixed at the calculated pipe set position. The valve device 15 is thus capable of setting an urging force of the spring 88 urging the needle 70 in the valve opening direction at a high degree of accuracy.

### Other Embodiments

(1) In the first through thirteenth embodiments above, the fuel injection valve as the valve device includes the intermediate member. However, the valve device including the intermediate member described in any one of the first through thirteenth embodiments above is not limited to the described configuration. As is described in the fourteenth embodiment above, the valve device may be a relief valve or a valve device configured to allow a fluid to flow from a first end to a second end while regulating a flow of a fluid from the second end to the first end. Further, as is described in the fifteenth embodiment above, the valve device may be an outward opening valve which closes upon supply of power.

(2) In the embodiments above, the needle and the movable core are provided separately. However, the needle and the movable core may be formed integrally. In such a case, the spring 29 or 89 urging the movable core toward the intermediate member may be omitted.

(3) In the first through thirteenth embodiments above, the fuel injection valve as the valve device includes the fixed core as the tubular member, the movable core, and the coil, and opens upon supply of power. However, the valve device of the present disclosure is not necessarily an electromagnetic valve which opens upon supply of power. As is described in the fourteenth embodiment above, the valve device may be a valve device which opens according to a pressure difference of a fluid.

(4) In the third embodiment above, the intermediate member included in the fuel injection vale has a communication hole functioning as an orifice. It should be appreciated, however, that the communication hole functioning as an orifice may be provided to the intermediate member included in the valve device of the fourteenth embodiment above and to the intermediate member included in the valve device of the fifteenth embodiment above. In a case where the intermediate member of the fourteenth embodiment has a communication hole with a relatively small inner diameter, an occurrence of cavitation in a fluid flowing inside the valve housing can be prevented.

(5) In the fourth embodiment above, the inner edge of the communication hole of the intermediate member on the side opposite to the injection hole has the inner-edge slope formed to be more distant from the center axis of the intermediate member on the side opposite to the injection hole than on the side of the injection hole. It should be appreciated, however, that the inner-edge slope may be provided to the valve device of any one of the third and seventh through fifteenth embodiments above.

(6) In the seventh embodiment above, the intermediate member has a protrusion as the first protrusion. In the eighth through tenth embodiments above, the intermediate member has a protrusion as the second protrusion. It should be appreciated, however, that the intermediate member included in the valve device of the present disclosure may have both the first protrusion and the second protrusion.

(7) In the thirteenth embodiment above, when an urging force of the spring is adjusted, the intermediate member is cooled and made movable relative to the fixed core. In such a case, a temperature of the intermediate member is restored to room temperature in practical use and the intermediate member becomes immovable relative to the fixed core. However, a method of making the intermediate member movable and immovable relative to the fixed core is not limited to the method described above.

When an urging force of the spring is adjusted, the intermediate member may be made movable relative to the fixed core by heating the fixed core and expanding the fixed core. In such a case, the intermediate member becomes immovable relative to the fixed core when a temperature of the fixed core is restored to room temperature in practical use. Alternatively, when an urging force of the spring is adjusted, the intermediate member may be made movable relative to the fixed core by heating the fixed core and expanding the fixed core while cooling the intermediate member. In such a case, the intermediate member becomes immovable relative to the fixed core when temperatures of the fixed core and the intermediate member are restored to room temperature in practical use.

(8) In the thirteenth embodiment above, the intermediate member also becomes movable relative to the fixed core when a temperature falls in an environment where the fuel injection valve is used. Given such circumstances, by making the intermediate member and the fixed core out of a same material, both contract to a same degree when cooled. Hence, the intermediate member does not fall off the fixed core. Consequently, the intermediate member can be prevented from moving due to resistance of fuel introduced from the fuel introduction pipe.

(9) In the first through tenth embodiments and the twelfth through fifteenth embodiments above, the adjusting pipe has a single communication passage at the center. In the eleventh embodiment above, the adjusting pipe has four notches on the radially outer side. However, positions and the number of the notches are not limited to the positions and the number specified above. It is sufficient for the adjusting pipe to have a space, through which a side of the adjusting pipe opposite to the injection hole and a side of the injection hole communicate with each other.

(10) In the second embodiment above, the first jig and the second jig included in the urging force adjusting device are separate members. However, the first jig and the second jig may be formed integrally.

(11) In the fifth and sixth embodiments, the first jig included in the urging force adjusting device is in contact with the intermediate member at one end having a tip-end slope or a spherical surface allowed to make contact with the inner-edge slope of the intermediate member. However, the first jig may have the tip-end slope or the spherical surface at the end making contact with the intermediate member even when the intermediate member does not have the inner-edge slope. Even in such a case, the first jig can be easily centered on the intermediate member.

(12) In the third through fifteenth embodiments above, the urging force adjusting device includes the calculation portion. However, the urging force adjusting device may include the storage portion instead of the calculation portion.

(13) In the tenth embodiment above, the urging force adjusting device includes the common jig prepared by forming the first jig and the second jig integrally. However, the first jig and the second jig may be separate members.

The present disclosure is not limited to the embodiment mentioned above, and can be applied to various embodiments which are also within the spirit and scope of the present disclosure.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

1-19. (canceled)

20. A valve device, comprising:
a valve housing having a hole through which a fluid flows, and a seat provided on a periphery of the hole;
a tubular member fixed to an inner side of the valve housing or formed integrally with the valve housing;
a valve member being slidable in the valve housing to open the hole when moving away from the seat and to close the hole when being in contact with the seat;
an urging member being in contact with the valve member at a first end of the urging member, the urging member urging the valve member in a valve closing direction or a valve opening direction;
an intermediate member being in contact with a second end of the urging member, the intermediate member providing immovably relative to the tubular member;
an adjusting member press-fit and fixed to an inner side of the tubular member to be in contact with the intermediate member on a side opposite to a side being in contact with the urging member, the adjusting member having a communication passage through which a side opposite to the hole and a side of the hole communicate with each other, the adjusting member configured to adjust an urging force of the urging member via the intermediate member according to a position relative to the tubular member when fixed to the tubular member; and
a swelling member provided between the intermediate member and the tubular member and configured to be in contact with the intermediate member and the tubular member by swelling when touched with a fluid flowing through the hole.

21. The valve device according to claim 20, wherein
the intermediate member has a communication hole through which a fluid flows, the communication hole communicating a side opposite to the hole and a side of the hole.

22. The valve device according to claim 21, wherein
the communication hole is an orifice.

23. The valve device according to claim 21, wherein
an inner edge of the communication hole on the side opposite to the hole has an inner-edge slope which becomes more distant from a center axis of the communication hole on the side opposite to the hole than on the side of the hole.

24. The valve device according to claim 20, wherein
the adjusting member has the communication passage that is a notch shape at an outer edge of the adjusting member.

25. The valve device according to claim 20, further comprising:
a movable core formed integrally with or separately from the valve member, the movable core provided to the side of the hole of the tubular member, the movable core being slidable in the valve housing together with the valve member or the movable core being slidable in the valve housing while being movable relative to the valve member; and
a coil configured to attract the movable core toward the tubular member when power is supplied, wherein
when the movable core is attracted toward the tubular member, the valve member moves in the valve opening direction to open the hole or the valve member moves in the valve closing direction to close the hole.

26. The valve device according to claim 20, wherein
the intermediate member has a first protrusion, at least a part of the first protrusion protruding toward the hole to be located on an inner side of the urging member.

27. The valve device according to claim 20, wherein
the intermediate member has a second protrusion protruding oppositely to the hole.

28. The valve device according to claim 27, wherein
an outer edge of the second protrusion on the side opposite to the hole has an outer-edge slope which comes closer to a center axis of the second protrusion on the side opposite to the hole than on the side of the hole.

29. The valve device according to claim 27, wherein
the second protrusion is provided to protrude from an end face of the adjusting member on the side opposite to the hole while an end face of the adjusting member on the side of the hole is in contact with the intermediate member.

30. A device for manufacturing a valve device, the device configured to adjust an urging force of the urging member included in the valve device according to claim 20, the device comprising:
a first jig configured to be in contact with the intermediate member;
a second jig configured to be in contact with the adjusting member and to push in the adjusting member press-fit to the tubular member toward the hole;
a detection portion detecting an urging force of the urging member based on an acting force acting on the first jig via the intermediate member;
a calculation portion calculating an adjusting member set position when an urging force of the urging member reaches a predetermined urging force based on the urging force of the urging member detected by the detection portion; and
a control portion controlling a pushing of the adjusting member by the second jig to locate the adjusting member at the adjusting member set position calculated by the calculation portion.

31. A device for manufacturing a valve device, the device configured to adjust an urging force of the urging member included in the valve device according to claim 20, the device comprising:
a first jig configured to be in contact with the intermediate member;
a second jig configured to be in contact with the adjusting member and to push in the adjusting member press-fit to the tubular member toward the hole;
a detection portion detecting an urging force of the urging member based on an acting force acting on the first jig via the intermediate member;
a storage portion storing an intermediate member set position as a position of the intermediate member relative to the tubular member when an urging force of the urging member reaches a predetermined urging force based on the urging force of the urging member detected by the detection portion; and
a control portion controlling a pushing of the adjusting member by the second jig to locate the intermediate member at the intermediate member set position stored in the storage portion.

32. The device for manufacturing the valve device according to claim 30, wherein
the first jig and the second jig are formed integrally.

33. The device for manufacturing the valve device according to claim 30, wherein
an outer edge of the first jig at an end on a side of the intermediate member has a tip-end slope which becomes more distant from a center axis of the first jig on a side opposite to the intermediate member than on a side of the intermediate member.

34. The device for manufacturing the valve device according to claim 30, wherein
an outer wall of the first jig at an end allowed to make contact with the intermediate member is formed in a spherical shape.

35. The device for manufacturing the valve device according to claim 30, wherein
an end face of the first jig on a side of the intermediate member and an end face of the second jig on a side of the adjusting member are flush with each other.
